(19) United States
(12) Patent Application Publication
(10) Pub. No.: US 2018/0237549 A1
(43) Pub. Date: Aug. 23, 2018

(54) COMPOSITE MATERIAL, PHOTOSENSITIVE RESIN COMPOSITION FOR SOLDER RESIST, AND PHOTOSENSITIVE ELEMENT

(71) Applicant: HITACHI CHEMICAL COMPANY, LTD., Chiyoda-ku, Tokyo (JP)

(72) Inventors: Kazumasa TAKEUCHI, Chiyoda-ku, Tokyo (JP); Kosuke YOKOYAMA, Chiyoda-ku, Tokyo (JP); Toshiaki SHIRASAKA, Chiyoda-ku, Tokyo (JP); Bungo OCHIAI, Yonezawa-shi, Yamagata (JP); Kazuki CHIBA, Yonezawa-shi, Yamagata (JP); Tomonari KIRYU, Yonezawa-shi, Yamagata (JP)

(21) Appl. No.: 15/753,068

(22) PCT Filed: Aug. 12, 2016
(86) PCT No.: PCT/JP2016/073792

§ 371 Date: Feb. 15, 2018

(30) Foreign Application Priority Data
Aug. 17, 2015 (JP) 2015-160619
Dec. 10, 2015 (JP) 2015-241233
Dec. 10, 2015 (JP) 2015-241461
Apr. 20, 2016 (JP) 2016-084666

(51) Int. Cl. C08F 2/44; C08F 220/18; C08L 33/12; B32B 27/26; C08J 5/18

(52) U.S. Cl. CPC C08F 2/44; C08F 220/18; C08F 2220/1816; B32B 27/26; C08J 5/18; C08L 33/12

(57) ABSTRACT

Disclosed is a composite material including a metal material; and a protective material provided on the surface of the metal material, the protective material being a cured product of a curable resin composition. The curable resin composition includes radical polymerizable monomers including a first monofunctional radical polymerizable monomer and a second monofunctional radical polymerizable monomer. The first monofunctional radical polymerizable monomer is a monomer that forms, when polymerized alone, a homopolymer having a glass transition temperature of 20° C. or lower. The second monofunctional radical polymerizable monomer is a monomer that forms, when polymerized alone, a homopolymer having a glass transition temperature of 50° C. or higher.

### TECHNICAL FIELD

The present invention relates to a composite material having a protective material, a curable resin composition used for forming the protective material of the composite material, a photosensitive resin composition for solder resist, and a photosensitive element.

### BACKGROUND ART

On the surface of a metal material, a protective material for preventing oxidative deterioration of the metal caused by moisture or oxygen or protecting the surface from various contaminants may be laminated. A plate-shaped metal material may be processed into the shape at the time of use via processing such as cutting, bending, or drawing; however, there are occasions in which a protective material is provided in order to prevent mechanical damage in processing processes. While a flexible protective material can conform to processing of the metal material, such as bending, a flexible protective material is inferior in the function of preventing mechanical damage. On the other hand, while a hard protective material is strong against mechanical damage, it is difficult for a hard protective material to conform to processing such as bending.

It is possible to process a metal material into a complicated shape; however, it is generally difficult to form a uniform protective material on the surface of a metal material having a complicated shape after processing.

As a composite material of a plastic and a metal, for example, a copper foil-attached polyimide film is commercially available, and a copper foil-attached polyimide film is utilized in order to produce, for example, a wiring board by processing the copper foil portion into an arbitrary shape. Generally, the surface of copper foil is subjected to a chemical treatment such as an anti-rust treatment; however, there are occasions in which a protective material is laminated on the copper foil in order to finally protect the copper foil. There are occasions in which these processed products are finally folded. While a flexible protective material is easily folded, a flexible protective material is inferior in the function of preventing mechanical damage. On the other hand, while a hard protective material is strong against mechanical damage, it is difficult to bend a hard protective material.

In order to obtain a material capable of achieving a balance between elongation and resistance to folding with characteristics that are in a trade-off relationship, such as strength and elastic modulus, various investigations have been hitherto conducted. For example, Patent Literature 1 discloses a cured article having a tensile modulus of 1 to 100 MPa and a tensile elongation at break of 200% or higher. Furthermore, Patent Literature 2 discloses a material that exhibits a high elastic modulus.

Meanwhile, regarding shape memory materials, metals, resins, ceramics, and the like are known. In general, shape memory properties are manifested based on the phase transformation caused by a change in the crystal structure or a change in the form of molecular motion. Many shape memory materials have characteristics such as excellent vibration-proofing characteristics, in addition to shape restoring characteristics. Heretofore, investigations have been mainly conducted on metals and resins as the shape memory materials.

A shape memory resin is a resin that, even if the resin is deformed due to a force exerted thereto after molding processing, restores the original shape when heated to or above a certain temperature. Compared to a shape memory alloy, a shape memory resin is generally excellent from the viewpoint of being inexpensive, having a high shape change ratio, and being lightweight, easily processable, and colorable.

Shape memory resins are soft at high temperature and are easily deformed like rubber. Meanwhile, shape memory resins are hard at low temperature and are not easily deformed, as in the case of glass. Shape memory resins can be stretched by a small force at high temperature to a length that is several times the original length and can retain the deformed shape by being cooled. When the material is heated in this state under non-loaded conditions, the material restores the original shape. At a high temperature, the material restores its original shape only by eliminating the force. Therefore, the characteristics of absorption and storage of energy at high temperature can be utilized.

Principal shape memory resins include polynorbornene, trans-isoprene, styrene-butadiene copolymers, and polyurethane. For example, shape memory resins are described in relation to a norbornene-based resin in Patent Literature 3, a trans-isoprene-based resin in Patent Literature 4, a polyurethane-based resin in Patent Literature 5, and an acrylic resin in Patent Literature 6.

Conventionally, along with size reduction, weight reduction, and thickness reduction of various electronic instruments, solder resist is used in printed wiring boards or package substrates having semiconductor elements built therein. Solder resist is an indispensable material as a protective film that prevents attachment of solder to unnecessary parts in a soldering process, and also as a permanent mask.

Regarding a method for forming solder resist, for example, a method of screen printing a thermosetting resin on a conductor layer of a printed wiring board is known. However, since there are limitations in the increase of the resolution of resist patterns, it has been difficult to adapt the method to densification of printed wiring boards in recent years.

Thus, in order to achieve an increase in the resolution of the resist patterns, a photoresist method has been actively used. A photoresist method is a method of forming a photosensitive layer comprising a photosensitive resin composition on a substrate, curing this photosensitive layer by exposing the layer to light in a predetermined pattern, removing unexposed parts by developing, and thereby forming a cured film having a predetermined pattern as solder resist. For example, Patent Literature 1 discloses a photosensitive thermosetting resin composition for solder resist, including an alkali-soluble resin having an imide ring, and the like.

In recent years, there is a demand for a material as a solder resist used in a flexible printed circuit (hereinafter, referred to as “FPC”) that is included in small-sized equipment such as cameras and mobile telephones, the material having flexibility that prevents destruction when a FPC is folded, and has micropattern-forming properties as well as conformity to circuit shapes.

### CITATION LIST

### Patent Literature

Patent Literature 1: Japanese Unexamined Patent Publication No. 2008-088354

Patent Literature 2: Japanese Unexamined Patent Publication No. 2012-102193

Patent Literature 3: Japanese Examined Patent Publication No. H5-72405

Patent Literature 4: Japanese Unexamined Patent Publication No. 2004-250182

Patent Literature 5: Japanese Unexamined Patent Publication No. 2004-300368

Patent Literature 6: Japanese Unexamined Patent Publication No. H7-292040

Patent Literature 7: WO 2015/052978 A

### SUMMARY OF INVENTION

### Technical Problem

An object of the present invention is to promote further improvements in view of resistance to folding, scratch resistance, and moisture-proofing properties, in connection with a protective material for protecting a metal material.

Another object of the present invention is to provide a novel photosensitive resin composition for solder resist, the resin composition being capable of forming a solder resist that has a high resolution and has satisfactory flexibility and strength; and a photosensitive element using this photosensitive resin composition.

### Solution to Problem

An aspect of the present invention relates to a composite material including a metal material; and a protective material that is a cured product of a curable resin composition, provided on the surface of the metal material. The curable resin composition includes radical polymerizable monomers including a first monofunctional radical polymerizable monomer and a second monofunctional radical polymerizable monomer. The first monofunctional radical polymerizable monomer is a monomer that forms, when polymerized alone, a homopolymer having a glass transition temperature of 20° C. or lower. The second monofunctional radical polymerizable monomer is a monomer that forms, when polymerized alone, a homopolymer having a glass transition temperature of 50° C. or higher. The total content of the first monofunctional radical polymerizable monomer and the second monofunctional radical polymerizable monomer in the curable resin composition may be 60% by mass or more based on the total amount of the radical polymerizable monomers.

The protective material included in this composite material can exhibit excellent effects in view of resistance to folding, scratch resistance, and moisture-proofing properties.

Another aspect of the present invention relates to a resin molded article comprising a first polymer containing a radical polymerizable compound represented by Formula (I):

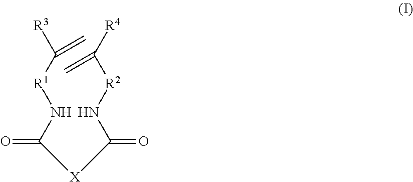

in which X, R¹, and R² each independently represent a divalent organic group; and R³ and R⁴ each represent a hydrogen atom or a methyl group, and a monofunctional radical polymerizable monomer, as monomer units; and a linear or branched second polymer.

This resin molded article may have a storage modulus of 0.5 MPa or higher at 25° C. Alternatively, the resin molded article may have shape memory properties. A relevant resin molded article has excellent heating-induced shape restorability.

Another aspect of the present invention relates to a composition for molding comprising radical polymerizable monomers (reactive monomers) including a radical polymerizable compound of Formula (I) and a monofunctional radical polymerizable monomer; and a second polymer. This composition for molding can form a resin molded article having a storage modulus of 0.5 MPa or higher at 25° C. when the radical polymerizable monomers are polymerized in the presence of the second polymer. Alternatively, this composition for molding can form a resin molded article having shape memory properties when the radical polymerizable monomers are polymerized in the presence of the second polymerizable monomer.

Another aspect of the present invention relates to a method for producing a resin molded article containing a first polymer and a second polymer. This method includes a step of producing a first polymer in a composition for molding that includes radical polymerizable monomers including a radical polymerizable compound of Formula (I) and a monofunctional radical polymerizable monomer, and a second polymer, the first polymer being produced by polymerization of the radical polymerizable monomers.

Another aspect of the present invention relates to a photosensitive resin composition for solder resist, the resin composition comprising reactive monomers including a radical polymerizable compound represented by Formula (I):

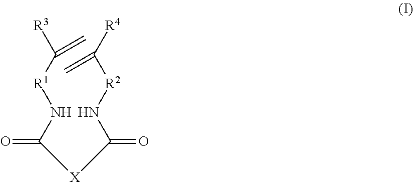

in which X, R¹, and R² each independently represent a divalent organic group; and R³ and R⁴ each independently represent a hydrogen atom or a methyl group, and a monofunctional radical polymerizable monomer; a linear or branched polymer; and a photopolymerization initiator.

Another aspect of the present invention relates to a photosensitive element comprising a support, and a photosensitive layer containing the photosensitive resin composition for solder resist, the photosensitive layer being provided on the support.

### Advantageous Effects of Invention

The protective material included in the composite material according to an aspect of the present invention can have excellent effects in view of resistance to folding (suppression of fracture, destruction, and detachment), scratch resistance, and moisture-proofing properties. The composite material can have stainproofing and waterproofing functions, owing to the protective material. The protective material can achieve a balance between, for example, an elastic modulus of 100 MPa or higher and an elongation of 300% or higher.

According to another aspect of the present invention, there is provided a resin molded article having shape memory properties, the resin molded article having excellent heating-induced shape restorability. The rate of shape restoration when heated can be easily increased by controlling the elastic modulus of the resin molded article of the present invention. A resin molded article according to several embodiments is also excellent in view of various characteristics such as transparency, flexibility, stress relaxation characteristics, and water resistance.

According to another aspect of the present invention, a photosensitive resin composition for solder resist, the resin composition being capable of forming a solder resist having a high resolution and having satisfactory flexibility and strength, and a photosensitive element obtained by using this photosensitive resin composition are provided. The photosensitive resin composition for solder resist and the photosensitive element of the present invention can have micropattern-forming properties and conformity to circuit shapes.

### BRIEF DESCRIPTION OF DRAWINGS

FIG. 1 is a cross-sectional view illustrating an embodiment of a composite material.

FIG. 2 is a cross-sectional view illustrating an embodiment of the composite material.

FIG. 3 is a cross-sectional view illustrating an embodiment of the composite material.

FIG. 4 is a cross-sectional view illustrating an embodiment of a photosensitive element.

### DESCRIPTION OF EMBODIMENTS

Hereinafter, some embodiments of the present invention will be described in detail. However, the present invention is not intended to be limited to the following embodiments.

Composite Material Having Metal Material and Protective Material

A composite material according to an embodiment has a metal material and a protective material provided on the surface of the metal material. The protective material is a layer of a cured product of a curable resin composition.

The curable resin composition according to an embodiment includes radical polymerizable monomers including a first monofunctional radical polymerizable monomer and a second monofunctional radical polymerizable monomer. The first monofunctional radical polymerizable monomer and the second monofunctional radical polymerizable monomer each have one radical polymerizable group. This curable resin composition can have, for example, an elastic modulus of 300 MPa or higher and an elongation of 300% or higher. A protective material that covers the surface of a metal material, or for example, a face where a metal material and a resin material exist in mixture, can be formed using the curable resin composition.

The first monofunctional radical polymerizable monomer is a monomer that forms, when polymerized alone, a homopolymer having a glass transition temperature of 20° C. or lower. The second monofunctional radical polymerizable monomer is a monomer that forms, when polymerized alone, a homopolymer having a glass transition temperature of 50° C. or higher. Due to a combination of these first monofunctional radical polymerizable monomer and second monofunctional radical polymerizable monomer, the cured product tends to have a high elongation at break and a high elastic elongation percentage. Furthermore, there is a tendency that a cured product having high strength at break is obtained. It is considered that these contribute to improvements in the resistance to folding, scratch resistance, and moisture-proofing properties of the protective material. From a similar point of view, the first radical polymerizable monomer may be a monomer that forms, when polymerized alone, a homopolymer of 10° C. or lower, or 0° C. or lower, and the second radical polymerizable monomer may be a monomer that forms, when polymerized alone, a homopolymer having a glass transition temperature of 60° C. or higher, or 70° C. or higher. The glass transition temperature of the homopolymer formed from the first monofunctional radical polymerizable monomer may be −70° C. or higher. The glass transition temperature of the homopolymer formed from the second monofunctional radical polymerizable monomer may be 150° C. or lower.

According to the present specification, the glass transition temperature of a homopolymer formed by each radical polymerizable monomer means a temperature determined by differential scanning calorimetry. Any person ordinarily skilled in the art can find the glass transition temperatures of homopolymers of general radical polymerizable monomers as literature values.

The content of the first monofunctional radical polymerizable monomer may be 5% by mass or more, 10% by mass or more, or 15% by mass or more, and may be 90% by mass or less, 85% by mass or less, or 80% by mass or less, based on the total amount of the radical polymerizable monomers. When the content of the first radical polymerizable monomer is within these ranges, a more remarkable effect is obtained from the viewpoint that the cured product can achieve a balance between high elongation at break and high elastic modulus.

The first monofunctional radical polymerizable monomer may be an alkyl (meth)acrylate which may have a substituent. A protective material containing a polymer that contains, as a monomer unit, an alkyl (meth)acrylate which may have a substituent can have satisfactory adhesiveness to a metal material. The alkyl (meth)acrylate that may have a substituent, which is used as the first monofunctional radical polymerizable monomer, can be, for example, at least one selected from the group consisting of ethyl acrylate, ethyl methacrylate, n-butyl acrylate, n-butyl methacrylate, isobutyl acrylate, isobutyl methacrylate, hexyl acrylate, hexyl methacrylate, 2-ethylhexyl acrylate, 2-ethylhexyl methacrylate, 2-hydroxyethyl methacrylate, 2-hydroxypropyl methacrylate, 2-hydroxy-1-methylethyl methacrylate, 2-methoxyethyl acrylate, and glycidyl methacrylate.

The first monofunctional radical polymerizable monomer may be 2-ethylhexyl acrylate. When 2-ethylhexyl acrylate is used, a more remarkable effect is obtained from the viewpoint that toughness and elongation at break of the cured product increase, and control of the elastic modulus becomes easy.

The content of the second monofunctional radical polymerizable monomer may be 10% by mass or more, 15% by mass or more, or 20% by mass or more, and may be 95% by mass or less, 90% by mass or less, or 85% by mass or less, based on the total amount of the radical polymerizable monomers. When the content of the second monofunctional radical polymerizable monomer is within these ranges, a more remarkable effect is obtained from the viewpoint that the cured product can achieve a high elongation at break and a high elastic modulus.

The second monofunctional radical polymerizable monomer may be an alkyl (meth)acrylate which may have a substituent. A protective material containing a polymer containing, as a monomer unit, an alkyl (meth)acrylate which may have a substituent can have satisfactory adhesiveness to a metal material. The alkyl (meth)acrylate that may have a substituent, which is used as the second monofunctional radical polymerizable monomer, can be, for example, at least one selected from the group consisting of adamantly acrylate, adamantly methacrylate, 2-cyanomethyl acrylate 2-cyanobutyl acrylate, acrylamide, acrylic acid, methacrylic acid, acrylonitrile, dicyclopentanyl acrylate, and methyl methacrylate.

The second monofunctional radical polymerizable monomer may be at least one selected from the group consisting of acrylonitrile, dicyclopentanyl acrylate, and methyl methacrylate. When these monomers are used, a more remarkable effect is obtained from the viewpoint that the strength at break and elastic elongation percentage of the cured product increase, and control of the elastic modulus becomes easy.

The ratio between the first monofunctional radical polymerizable monomer and the second monofunctional radical polymerizable monomer can be regulated as appropriate. As the ratio of the first monofunctional radical polymerizable monomer is higher, there is a tendency that the elastic modulus and the glass transition temperature of the cured product decrease, and the elongation at break increases. As the ratio of the second monofunctional radical polymerizable monomer is higher, there is a tendency that the elastic modulus and the glass transition temperature of the cured product increase.

The curable resin composition can further include a monomer other than the first monofunctional radical polymerizable monomer and the second monofunctional radical polymerizable monomer as the radical polymerizable monomer. However, the total content of the first monofunctional radical polymerizable monomer and the second monofunctional radical polymerizable monomer may be 60% by mass or more, 70% by mass or more, or 80% by mass or more, based on the total amount of the radical polymerizable monomers. When the total content of the first monofunctional radical polymerizable monomer and the second monofunctional radical polymerizable monomer is within these ranges, a more remarkable effect is obtained from the viewpoint that the cured product has a high elongation at break and a high elastic elongation percentage.

The radical polymerizable monomers in the curable resin composition may also include a polyfunctional radical polymerizable monomer having two or more radical polymerizable groups, and/or a monofunctional radical polymerizable monomer other than the first monofunctional radical polymerizable monomer and the second radical polymerizable monomer (a monomer that forms, when polymerized alone, a homopolymer of higher than 20° C. and lower than 50° C.).

When the radical polymerizable monomers include a polyfunctional polymerizable monomer, the cured product tends to have high strength at break and excellent solvent resistance. The curable resin composition may also include a bifunctional radical polymerizable monomer and/or a trifunctional radical polymerizable monomer as the polyfunctional radical polymerizable monomer. The content of the polyfunctional radical polymerizable monomer may be 0.01% by mass or more, 0.05% by mass or more, or 0.1% by mass or more, and may be 10% by mass or less, 8.0% by mass or less, or 5.0% by mass or less, based on the total amount of the radical polymerizable monomers. The content of the polyfunctional radical polymerizable monomer is within these ranges, there is a tendency that a balance can be achieved at a particularly high level between the strength at break and the elongation at break of the cured product.

The polyfunctional radical polymerizable monomer may be a polyfunctional (meth)acrylate, from the viewpoint of compatibility with other components. The polyfunctional (meth)acrylate may be a bifunctional (meth)acrylate and/or a trifunctional (meth)acrylate. By using a bifunctional and/or trifunctional (meth)acrylate, a more advantageous effect is obtained from the viewpoint of achieving a balance between the strength at break and the elongation at break of the cured product. The bifunctional and/or trifunctional (meth)acrylate may include a cyclic structure or may form a cyclic structure by a curing reaction.

Examples of the bifunctional or trifunctional (meth)acrylate include 1,3-butylenediol di(meth)acrylate, 1,4-butanediol di(meth)acrylate, 1,6-hexanediol di(meth)acrylate, 1,9-nonanediol di(meth)acrylate, 1,10-decanediol di(meth)acrylate, polyethylene glycol di(meth)acrylate, polypropylene glycol di(meth)acrylate, polytetraethylene glycol di(meth)acrylate, neopentyl glycol di(meth)acrylate, ethoxy-modified bisphenol A di(meth)acrylate, tris(2-(meth)acryloyloxyethyl) isocyanurate, trimethylolpropane tri(meth)acrylate, and pentaerythritol tri(meth)acrylate. These can be used singly or in combination of two or more kinds thereof.

The total content of the bifunctional (meth)acrylate and trifunctional (meth)acrylate may be 0.1% by mass or more, 0.2% by mass or more, or 0.5% by mass or more, and may be 10% by mass or less, 8.0% by mass or less, or 5.0% by mass or less, based on the total amount of the radical polymerizable monomers.

The curable resin composition may also include a radical polymerization initiator for the polymerization of the radical polymerizable monomers. The radical polymerization initiator may be a thermal radical polymerization initiator, a photoradical polymerization initiator, or a combination thereof. The content of the radical polymerization initiator is adjusted as appropriate in a conventional range; however, the content may be, for example, 0.001% to 5% by mass based on the mass of the curable resin composition.

Examples of the thermal radical polymerization initiator include organic peroxides such as a ketone peroxide, a peroxy ketal, a dialkyl peroxide, a diacyl peroxide, a peroxy ester, a peroxy dicarbonate, and a hydroperoxide; persulfates such as sodium persulfate, potassium persulfate, and ammonium persulfate; azo compounds such as 2,2′-azobis-isobutyronitrile (AIBN), 2,2′-azobis-2,4-dimethylvaleronitrile (ADVN), 2,2′-azobis-2-methylbutyronitrile, and 4,4′-azobis-4-cyanovaleric acid; alkyl metals such as sodium ethoxide and tert-butyllithium; and silicon compounds such as 1-methoxy-1-(trimethylsiloxy)-2-methyl-1-propene.

A thermal radical polymerization initiator and a catalyst may be used in combination. Examples of this catalyst include metal salts, and compounds having a reducing ability, such as tertiary amine compounds such as N,N,N′,N′-tetramethylethylenediamine.

Examples of the photoradical polymerization initiator include aromatic ketones such as benzophenone, 2-benzyl-2-dimethylamino-1-(4-morpholinophenyl)-butanone-1,2-meth yl-1-[4-(methylthio)phenyl]-2-morpholinopropanone-1,2,2-dimethoxy-1,2-diphenylethan-1-one (Irgacure 651 (manufactured by Ciba-Geigy Japan, Ltd.)); quinone compounds such as an alkylanthraquinone; benzoin ether compounds such as a benzoin alkyl ether; benzoin compounds such as benzoin and an alkylbenzoin; benzyl derivatives such as benzyl dimethyl ketal; 2,4,5-triarylimidazole dimers such as a 2-(2-chlorophenyl)-4,5-diphenylimidazole dimer and a 2-(2-fluorophenyl)-4,5-diphenylimidazole dimer; and acridine derivatives such as 9-phenylacridine and 1,7-(9,9′-acridinyl)heptane. The photopolymerization initiators can be used singly or in combination of two or more kinds thereof.

The curable resin composition according to an embodiment may further include a linear or branched polymer containing a polyoxyalkylene chain (hereinafter, may be referred to as “modifying polymer”). The modifying polymer usually does not have a radical polymerizable group and is incorporated into the curable resin composition as a component different from the radical polymerizable monomer.

A plurality of oxyalkylene groups that constitute the polyoxyalkylene chain in the modifying polymer may be identical with or different from each other. The polyoxyalkylene chain may be a random copolymer in which two or more kinds of oxyalkylene groups are irregularly arranged, or may be a block copolymer containing blocks in each of which the same oxyalkylene groups are successively linked. The polyoxyalkylene chain can be derived from, for example, a polyether such as a polyalkylene glycol.

The polyoxyalkylene chain in the modifying polymer may be a polyoxyethylene chain, a polyoxypropylene chain, a polyoxybutylene chain, or a combination thereof. Particularly, the polyoxyalkylene chain in the modifying polymer may be a polyoxyethylene chain, a polyoxypropylene chain, or a combination thereof.

The proportion of the polyoxyalkylene chain in the modifying polymer may be 20% to 60% by mass based on the mass of the modifying polymer. Thereby, an effect of enhancing the mechanical characteristics of the resin molded article according to the present invention is more noticeably provided.

A polyoxyethylene chain is easily entangled with the molecular chains of a polymer formed by polymerization of radical polymerizable monomers including a monofunctional radical polymerizable monomer, and has a slippery structure in which the portions where entanglement has occurred can easily move around. That is, it is contemplated that as polyoxyethylene chains are entangled with the molecular chains of other polymers, a pseudo-crosslinked structure in which entanglement points can slip and move freely is formed. When a pseudo-crosslinked structure is formed, the stress exerted at the various crosslinking points on an occasion in which the resin molded article is deformed is uniformly dispersed, and thereby strength and elongation of the resin molded article are increased.

The proportion of the polyoxyethylene chain may be 20% by mass or more, 30% by mass or more, or 40% by mass or more, based on the total mass of the polyoxyalkylene chains in the modifying polymer. When the proportion of the polyoxyethylene chain is high to a certain extent, the resin molded article obtained after curing can have especially excellent mechanical properties in view of strength, elongation, and the like. The proportion of polyoxyethylene chains may also be 70% by mass or less, 60% by mass or less, or 50% by mass or less, based on the total mass of the polyoxyalkylene chains in the modifying polymer. Thereby, crystallinity of the modifying polymer is suppressed. When crystallization is suppressed, the modifying polymer is likely to have high compatibility with other components and can have appropriately low viscosity.

The number average molecular weight of the polyoxyalkylene chains that constitute the modifying polymer is not particularly limited; however, the number average molecular weight may be, for example, 500 or more, 1,000 or more, or 3,000 or more. When the molecular weight of the polyoxyalkylene chains is large, formation of a pseudo-crosslinked structure tends to be promoted. The number average molecular weight of the polyoxyalkylene chains may also be 20,000 or less, 15,000 or less, or 10,000 or less. Thereby, the modifying polymer is likely to have high compatibility with other components and can have appropriately low viscosity. According to the present specification, unless particularly defined, the number average molecular weight and the weight average molecular weight mean values that are determined by gel permeation chromatography and are calculated relative to polystyrene standards.

The modifying polymer may contain two or more polyoxyalkylene chains and a linking group that connects those chains. A modifying polymer having a linking group contains, for example, a molecular chain represented by the following Formula (X). In Formula (X), R²¹ represents an oxyalkylene group; n¹¹, n¹², and n¹³ each independently represent an integer of 1 or greater; and L represents a linking group. A plurality of R²¹'s and L's in the same molecule may identical with or different from each other.

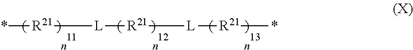

The oxyalkylene group of R²¹ is represented by, for example, the following Formula (Y). In Formula (Y), R²² represents a hydrogen atom or an alkyl group having 4 or fewer carbon atoms; and n²⁰ represents an integer from 2 to 4. A plurality of R²²'s and n²⁰'s in the same molecule may be identical with or different from each other.

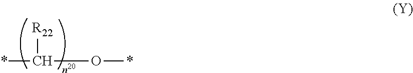

The linking group L in Formula (X) is a divalent organic group that connects two polyoxyalkylene chains. The linking group L may be an organic group containing a cyclic group, or a branched organic group. For example, the linking group may also be a divalent group represented by the following Formula (30).

*—Z⁵—R³⁰—Z⁶—* (30)

R³⁰ represents a cyclic group; a group containing two or more cyclic groups that are bonded to each other directly or via an alkylene group; or a branched organic group that contains carbon atoms and may contain a heteroatom selected from an oxygen atom, a nitrogen atom, a sulfur atom, and a silicon atom. Z⁵ and Z⁶ each represent a divalent group that links R³⁰ with a polyoxyalkylene chain, which is a linear chain, and examples thereof include groups represented by —NHC(═O)—, —NHC(═O)O—, —O—, —OC(═O)—, —S—, —SC(═O)—, —OC(═S)—, or —NR¹⁰— (wherein R¹⁰ represents a hydrogen atom or an alkyl group).

The cyclic group contained in the linking group L may contain a heteroatom selected from a nitrogen atom and a sulfur atom. The cyclic group contained in the linking group L may be an alicyclic group, a cyclic ether group, a cyclic amine group, a cyclic thioether group, a cyclic ester group, a cyclic amide group, a cyclic thioester group, an aromatic hydrocarbon group, a heteroaromatic hydrocarbon group, or a combination thereof. Specific examples of the cyclic group contained in the linking group L include a 1,4-cyclohexanediyl group, a 1,2-cyclohexanediyl group, a 1,3-cyclohexanediyl group, a 1,4-benzenediyl group, a 1,3-benzenediyl group, a 1,2-benzenediyl group, and a 3,4-furandiyl group.

Examples of the branched organic group contained in the linking group L (for example, R³⁰ in Formula (30)) include a lysinetriyl group, a methylsilanetriyl group, and a 1,3,5-cyclohexanetriyl group.

The linking group L represented by Formula (30) may be a group represented by the following Formula (31). R³¹ in Formula (31) represents a single bond or an alkylene group. R³¹ may also be an alkylene group having 1 to 3 carbon atoms. Z⁵ and Z⁶ have the same definitions as Z⁵ and Z⁶ of Formula (30), respectively.

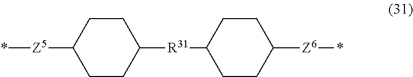

It is speculated that by introducing a sterically bulky cyclic structure or branched structure into the linking group L, when the resin molded article is deformed under stress, irreversible dissolution in the entanglement of molecular chains formed by the polyoxyalkylene chains does not easily occur. The inventors of the present invention considered that this contributes to a balance between high elongation of the resin molded article and the manifestation of shape restorability after deformation.

The weight average molecular weight of the modifying polymer is not particularly limited; however, for example, the weight average molecular weight may be 3,000 or more, 5,000 or more, or 8,000 or more, and may be 150,000 or less, 100,000 or less, or 50,000 or less. When the weight average molecular weight of the modifying polymer is within these numerical ranges, the modifying polymer is likely to have satisfactory compatibility with other components, and the resin molded article can be especially excellent mechanical characteristics in view of strength, elongation, and the like.

As will be understood by those ordinarily skilled in the art, the modifying polymer can be obtained by a conventional synthesis method by using conventionally available raw materials as starting materials. For example, the modifying polymer may be a reaction product between a bifunctional alcohol having a polyoxyalkylene chain and a hydroxyl group at both terminals (a polyalkylene glycol or the like) and a compound having a functional group that reacts with a hydroxyl group (an isocyanate group or the like) and a cyclic group or a branched group (a bifunctional isocyanate or the like). The modifying polymer to be synthesized may contain a branched structure based on side reactions such as trimerization of isocyanate groups. In a case in which a bifunctional alcohol is used as a synthesis raw material, the number average molecular weight of the bifunctional alcohol may be 500 to 200,000.

The structure of the modifier polymer can be characterized by, for example, the molecular weight and the molecular weight distribution, the linking group, and the structure and the proportion of the oxyalkylene structure. Whereas, the structure of the modifying polymer can also be changed significantly by factors other than these, for example, the arrangement of the various constituent units and the steric structure. However, it is generally difficult to check the arrangement of the constituent units by a realistic method. Therefore, in order to characterize the structure of the modifying polymer, there may be occasions in which it is required to define the synthesis conditions or the kinds and proportions of the raw materials used.

The content of the modifying polymer in the curable resin composition may be 1% by mass or more, 3% by mass or more, or 5% by mass or more, based on the mass of the curable resin composition. Thereby, an effect of enhancing the mechanical characteristics of the resin molded article brought by the modifying polymer is particularly significantly provided. The content of the modifying polymer may also be 20% by mass or less, 15% by mass or less, or 10% by mass or more. Thereby, high compatibility with components other than the modifying polymer can be secured. When compatibility is high, a transparent resin molded article that does not undergo phase separation is likely to be obtained.

The curable resin composition may also include, if necessary, a binder polymer, a solvent, a photocolor developer, a thermal color development inhibitor, a plasticizer, a pigment, a filler, a flame retardant, a stabilizer, a tackifier, a leveling agent, a peeling accelerator, an oxidation inhibitor, a fragrance, an imaging agent, a thermal crosslinking agent, and the like. These can be used singly or in combination of two or more kinds thereof. In a case in which the curable resin composition includes those other components, the content of the components may be 0.01% by mass or more, and may be 20% by mass or less, based on the mass of the curable resin composition.

The cured product can be produced by a method including a step of radical-polymerizing the radical polymerizable monomers in the curable resin composition and thereby curing the curable resin composition. Radical polymerization of the radical polymerizable monomers can be initiated by heating, or irradiation with active light rays such as ultraviolet radiation.

In regard to the radical polymerization, there is a tendency that generally, a polymer having a high molecular weight is obtained by lowering the rate of radical generation caused by decomposition of the radical polymerization initiator. The rate of radical generation can be controlled by the conditions for radical polymerization. There are methods such as adjusting the amount of the radical polymerization initiator to be a small amount, lowering the heating temperature for thermal radical polymerization, and lowering the illuminance of active light rays for photoradical polymerization.

There are no particular limitations on the conditions for radical polymerization for curing the curable resin composition; however, the conditions can be set in view of the circumstances described above. The temperature for thermal radical polymerization may be, for example, within plus or minus 10° C. of the decomposition temperature of the radical polymerization initiator. In a case in which the curable resin composition includes a solvent, this temperature may be lower than or equal to the boiling point of the solvent. The illuminance of photoradical polymerization may be, for example, 1 mW/cm² or lower. As the molecular weight of the polymer thus formed is larger, the elongation at break of the cured product tends to increase, and a balance may be easily achieved between high elastic modulus and high elongation at break.

The radical polymerization reaction can be carried out in an atmosphere of an inert gas such as nitrogen gas, helium gas, or argon gas. Thereby, polymerization inhibition caused by oxygen is suppressed, and a cured product having satisfactory product quality can be stably obtained.

The glass transition temperature of the cured product is not particularly limited; however, for example, the glass transition temperature may be 30° C. or higher, or may be 40° C. or higher. When the glass transition temperature is higher than or equal to room temperature or the use temperature, a high elastic modulus is likely to be maintained at the time of use, and it is advantageous in view of having excellent handleability. The glass transition temperature can be regulated by, for example, the mixing ratio between the first monofunctional radical polymerizable monomer and the second monofunctional radical polymerizable monomer in the curable resin composition.

The elastic modulus (tensile modulus) of the cured product may be 10 MPa or higher, 100 MPa or higher, or 200 MPa or higher, and may be 10 GPa or lower, 7 GPa or lower, or 5 GPa or lower. When the elastic modulus of the cured product is within the range described above, there is a tendency that a balance between the elongation at break and the elastic elongation percentage is easily achieved. The elastic modulus can be regulated by, for example, the mixing ratio between the first monofunctional radical polymerizable monomer and the second monofunctional radical polymerizable monomer in the curable resin composition.

The elongation at break of the cured product may be 10% or higher, 100% or higher, or 200% or higher. When the elongation at break of the cured product is in the above-mentioned range, powder fall does not occur during cutting processing of the composite material, and an advantageous effect is obtained in view of exhibiting characteristics such as satisfactory foldability and crack resistance.

The weight average molecular weight of the polymer that forms the cured product (polymer of the radical polymerizable monomers) may be 100,000 or more, or 200,000 or more. As the weight average molecular weight is larger, the elongation at break tends to increase. According to the present specification, unless particularly defined otherwise, the weight average molecular weight means a value determined by gel permeation chromatography and calculated relative to polystyrene standards.

A cured product having excellent shape restorability after being deformed under stress has a high elastic elongation percentage. The elastic elongation percentage of the cured product may be 60% or higher, 70% or higher, or 80% or higher, and may be 1,000% or lower.

The elastic elongation percentage is measured by, for example, the following procedure.

(1) A specimen of a cured product having a size of 5 mm×50 mm is prepared, and marks are made at three sites along the longitudinal direction in an area corresponding to the chuck distance. The distances between the various marks are designated as L0 and L0′.

(2) A tensile test is performed with a tensile testing machine under the conditions of a measurement temperature of 25° C., a tensile rate of 10 mm/min, and a distance between chucks L1 of 30 mm.

(3) For the specimen obtained immediately after fracture, marks at two points where there is no site of fracture between marks are selected from among the three marks, and the distance between those marks L2 is measured. In a case in which the initial length corresponding to this portion is L0, the elongation at break is calculated by formula: (L2−L0)/L0. In a case in which the initial length is L0′, the elongation at break is calculated by formula: (L2−L0′)/L0′. Alternatively, the elongation at break may also be calculated by formula: (L3−L1)/L1, using the distance between chucks L3 at the time of fracture.

(4) The specimen after fracture is heated for 3 minutes at 70° C., and the distance between marks L4 after heating is measured. The elastic elongation percentage, which represents the proportion of elastic elongation with respect to the elongation at break, is calculated by formula: (L2−L4)/(L2−L0). The distance L2 immediately after fracture may be calculated by formula: L2=L3×(L0/L1), by utilizing the distance between chucks L3.

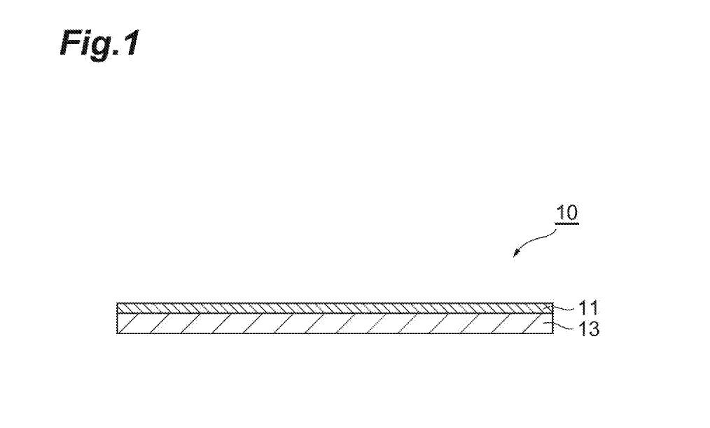

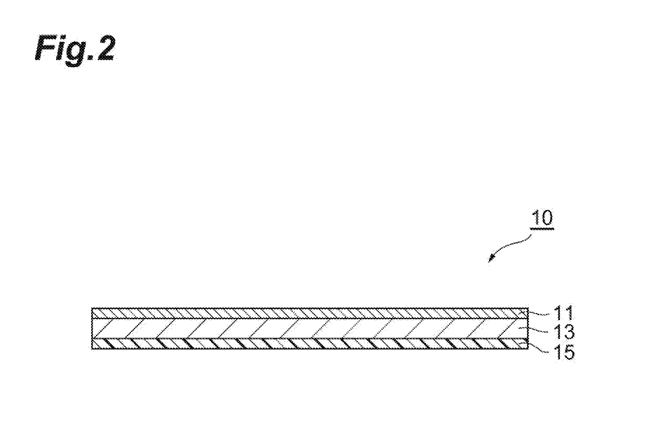

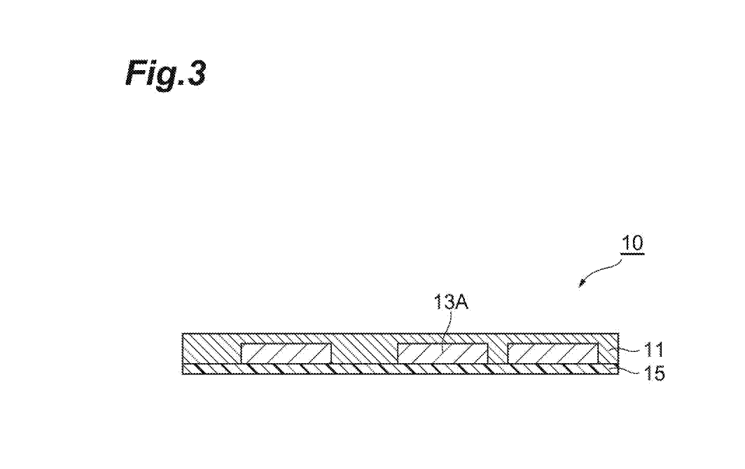

FIG. 1, FIG. 2, and FIG. 3 are each a cross-sectional view illustrating an embodiment of the composite material. The composite material 10 illustrated in FIG. 1 has a plate-shaped metal material 13; and a film-shaped protective material 11 provided on one of the principal faces of the metal material 13. The composite material 10 illustrated in FIG. 2 has a resin layer 15; a plate-shaped metal material 13 provided on one of the principal faces of the resin layer 15; and a film-shaped protective material 11 provided on a principal face of the metal material 13, the principal face being on the opposite side from the resin layer 15. The composite material 10 illustrated in FIG. 3 has a resin layer 15; a metal material 13A provided on one of the principal faces of the resin layer 15 and having a pattern; a film-shaped protective material 11 provided on a principal face of the metal material 13, the principal face being on the opposite side from the resin layer 15, the protective material 11 covering the resin layer 15 and the metal material 13.

The metal material 13 that constitutes the composite material is not particularly limited; however, the metal material 13 may be, for example, a sheet-shaped article or a foil formed from copper, aluminum, iron, nickel, zinc, gold, silver, tin, lead, stainless steel or a combination thereof, or an alloy such as Alloy 42, galvanized iron, tin-plated iron, or brass. The thickness of the metal material in the form of a sheet-shaped article or a foil may be, for example, 5 to 500 μm.

The resin layer 15 that constitutes the composite material may be, for example, a polyimide film or a polyethylene terephthalate film. The thickness of the resin layer 15 may be, for example, 10 to 200 μm.

Examples of a laminate including a combination of the metal material 13 and the resin layer 15 include a copper foil-attached polyimide film, a copper foil-attached polyethylene terephthalate film, and an aluminum-deposited polyethylene terephthalate film.

The thickness of the protective material is not particularly limited; however, the thickness may be, for example, 10 to 1,000 μm.

The composite material 10 can be obtained by a method of forming a film of a curable resin composition on the surface of a metal material 13, or on the surface of the metal material 13 side of a laminate having a metal material 13 and a resin layer 15; curing the curable resin composition film thus formed by means of light, heat, or a combination thereof; and thereby forming a film-shaped protective material 11. A film of the curable resin composition can be formed by, for example, flow casting the composition by methods such as bar coating, spray coating, dispenser coating, dip coating, and gravure coating. When the film of the curable resin composition thus formed is cured, oxygen may be blocked as appropriate. For example, the surface of the film of the curable resin composition may be covered with a film or the like, and the curable resin composition may be cured in a nitrogen atmosphere.

Composition for Molding

A composition for molding according to an embodiment includes radical polymerizable monomers including a radical polymerizable compound represented by Formula (I):

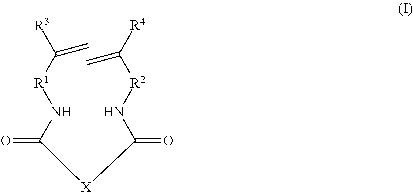

and a monofunctional radical polymerizable monomer; and a second polymer. In Formula (I), X, R¹, and R² each independently represent a divalent organic group; and R³ and R⁴ each independently represent a hydrogen atom or a methyl group. When the radical polymerizable monomers are polymerized in the composition for molding, a first polymer composed of monomer units derived from those radical polymerizable monomers is produced. Thereby, the reaction product is cured, and a resin molded article (cured article) is formed. The first polymer is usually formed as a polymer separate from the second polymer in the molded article, without being bonded to the second polymer by covalent bonding.

The first polymer can contain a cyclic monomer unit represented by the following Formula (II), which is derived from the compound of Formula (I). It is considered that the cyclic monomer unit of Formula (II) contributes to the manifestation of unique characteristics such as shape memory properties of the resin molded article. However, it is not necessarily essential for the first polymer to contain the monomer unit of Formula (II).

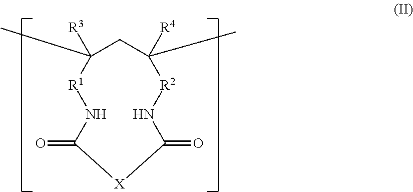

X in Formulae (I) and (II) may also be, for example, a group represented by the following Formula (10):

*—Z¹—(CH₂)ᵢ—Y—(CH₂)ⱼ—Z²—* (10)

In Formula (10), Y represents a cyclic group which may have a substituent; Z¹ and Z² each independently represent a functional group containing an atom selected from a carbon atom, an oxygen atom, a nitrogen atom, and a sulfur atom; and i and j each independently represent an integer from 0 to 2. The symbol * represents a linking point (this is also the same for other formulae). It is considered that when X represents a group of Formula (10), the cyclic monomer unit of Formula (II) may be particularly easily formed. The configuration of Z¹ and Z² with respect to the cyclic group Y may be the cis-position or may be the trans-position. Z¹ and Z² may also be groups represented by —O—, —OC(═O)—, —S—, —SC(═O)—, —OC(═S)—, —NR¹⁰— (wherein R¹⁰ represents a hydrogen atom or an alkyl group), or —ONH—.

Y may be a cyclic group having 2 to 10 carbon atoms, and may also contain a heteroatom selected from an oxygen atom, a nitrogen atom, and a sulfur atom. This cyclic group Y may be, for example, an alicyclic group, a cyclic ether group, a cyclic amine group, a cyclic thioether group, a cyclic ester group, a cyclic amide group, a cyclic thioester group, an aromatic hydrocarbon group, a heteroaromatic hydrocarbon group, or a combination thereof. The cyclic ether group may be a cyclic group carried by a monosaccharide or a polysaccharide. Specific examples of Y include, but are not particularly limited to, cyclic groups represented by the following Formulae (11), (12), (13), (14), and (15). From the viewpoint of stress relaxation characteristics of the resin molded article, Y may also be a group of Formula (II) (particularly, a 1,2-cyclohexanediyl group).

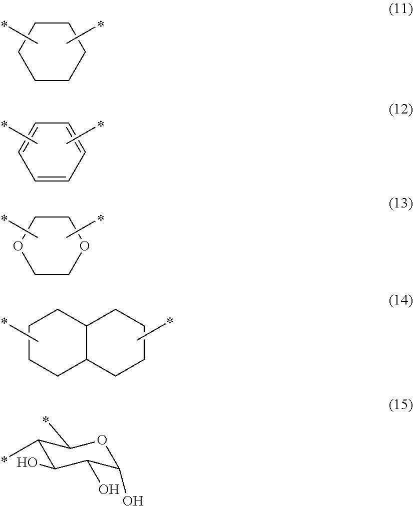

R¹ and R² in Formulae (I) and (II) may be identical with or different from each other, and may each represent a group represented by the following Formula (20).

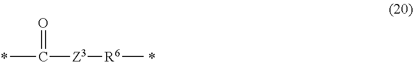

In Formula (20), R⁶ represents a hydrocarbon group (alkylene group or the like) having 1 to 8 carbon atoms and is bonded to a nitrogen atom in Formula (I) or (II). Z³ represents a group represented by —O— or —NR¹⁰— (wherein R¹⁰ represents a hydrogen atom or an alkyl group). It is considered that when R¹ and R² both represent a group of Formula (20), a cyclic monomer unit of Formula (II) may be particularly easily formed. The number of carbon atoms of R⁶ may be 2 or more and may be 6 or less, or 4 or less.

One specific example of the radical polymerizable compound of Formula (I) is a compound represented by the following Formula (Ia). Here, Y, Z¹, Z², i, and j have the same definitions as Y, Z¹, Z², i, and j of Formula (10), respectively.

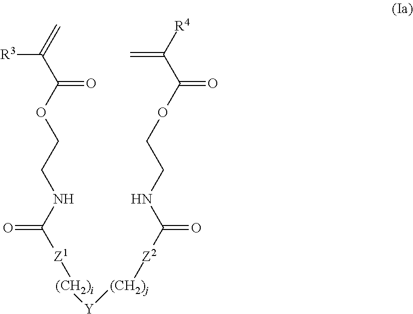

Examples of the compound of Formula (Ia) include compounds represented by the following Formulae (I-1), (I-2), (I-3), (I-4), (I-5), (I-6), (I-7), or (I-8).

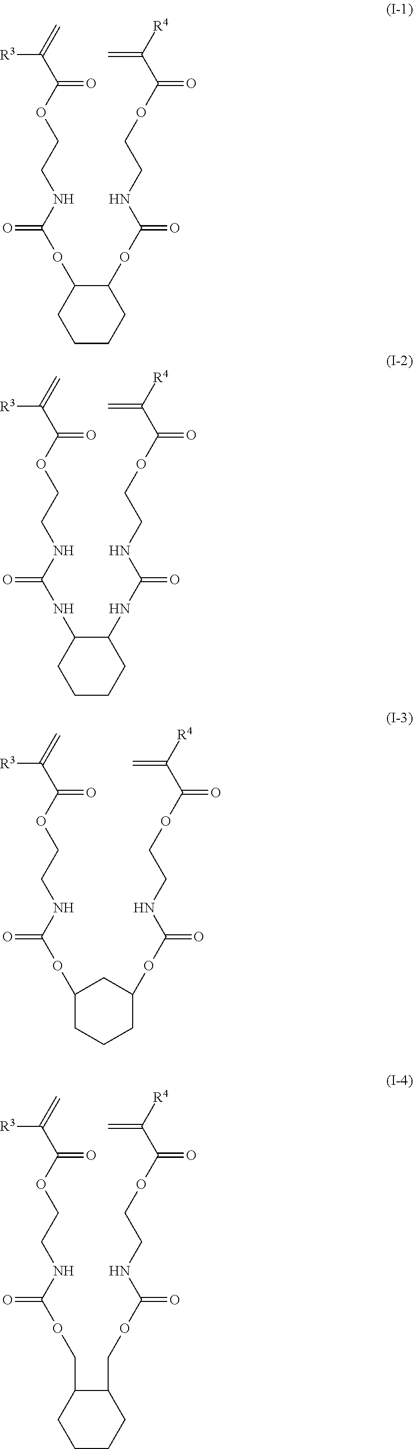

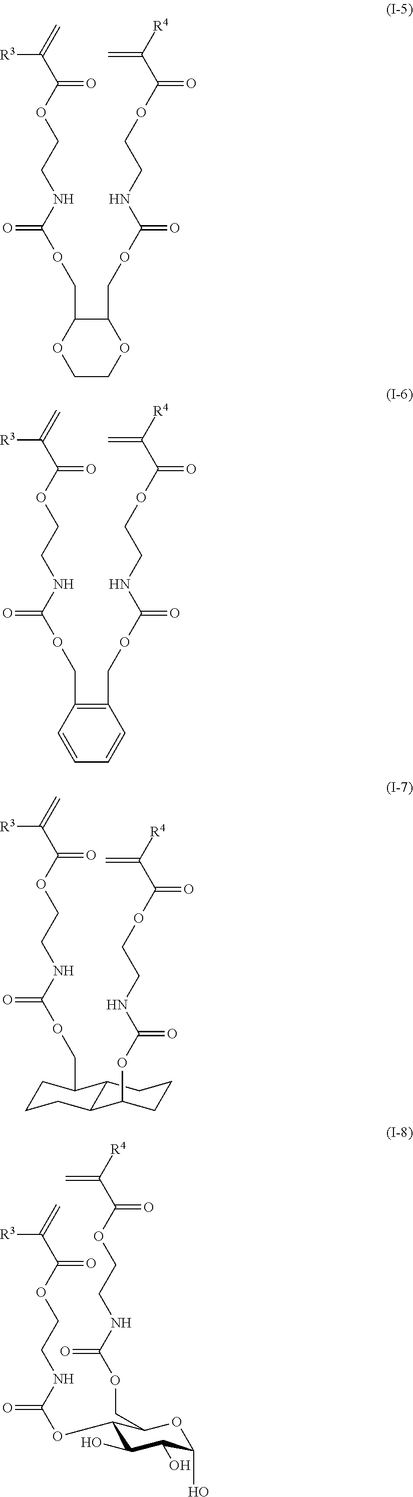

The compounds listed above as examples can be used singly or in combination of two or more kinds thereof.

The proportion of the radical polymerizable compound of Formula (I) in the composition for molding may be 0.01 mol % or more, 0.1 mol % or more, or 0.5 mol % or more, and may be 10 mol % or less, 5 mol % or less, or 1 mol % or less, based on the total amount of the radical polymerizable monomers. When the proportion of the radical polymerizable compound of Formula (I) is within these ranges, a more advantageous effect is obtained from the viewpoint that a cured article having excellent mechanical characteristics such as elongation, strength, and folding resistance is obtained.

The compound of Formula (I) can be synthesized by a conventional synthesis method by using conventionally available raw materials as starting materials, as will be understood by those ordinarily skilled in the art. For example, a compound of Formula (I) can be synthesized by a reaction between a cyclic diol compound or a cyclic diamine compound and a compound having a (meth)acryloyl group and an isocyanate group.

The radical polymerizable monomers in the composition for molding may include an alkyl (meth)acrylate and/or acrylonitrile as a monofunctional radical polymerizable monomer.

The alkyl (meth)acrylate may be an alkyl (meth)acrylate having an alkyl group with 1 to 16 carbon atoms, which may have a substituent (an ester between (meth)acrylic acid and an alkyl alcohol having 1 to 16 carbon atoms, which may have a substituent). The substituent that may be carried by the alkyl (meth)acrylate having an alkyl group with 1 to 16 carbon atoms may contain an oxygen atom and/or a nitrogen atom.

When the radical polymerizable monomers include an alkyl (meth)acrylate having an alkyl group with 1 to 16 carbon atoms, advantageous effects that the elastic modulus, glass transition temperature (Tg), and mechanical characteristics such as elongation and strength, of the cured article can be controlled, are obtained.

The proportion of the alkyl (meth)acrylate having 1 to 16 carbon atoms, which may have a substituent, in the composition for molding may be 10 mol % or more, 15 mol % or more, or 20 mol % or more, and may be 95 mol % or less, 90 mol % or less, or 85 mol % or less, based on the total amount of the radical polymerizable monomers. When the proportion of the alkyl (meth)acrylate having 1 to 16 carbon atoms, which may have a substituent, is within these ranges, a more advantageous effect is obtained from the viewpoint of obtaining a cured article having excellent mechanical characteristics such as elongation and strength and excellent folding resistance.

When an alkyl (meth)acrylate having an alkyl group with a small number of carbon atoms is used, there is a tendency that the elastic modulus of the resin molded article obtainable after curing increases, and shape memory properties are easily manifested. From such a viewpoint, the radical polymerizable monomers may include an alkyl (meth)acrylate having an alkyl group with 10 or fewer carbon atoms, which may have a substituent, as a monofunctional radical polymerizable monomer. The proportion of the alkyl (meth)acrylate having 10 or fewer carbon atoms, which may have a substituent, may be 8 mol % or more, 10 mol % or more, or 15 mol % or more, and may be 55 mol % or less, 45 mol % or less, or 25 mol % or less, based on the total amount of the radical polymerizable monomers. When the proportion of the alkyl (meth)acrylate having an alkyl group with 10 or fewer carbon atoms, which may have a substituent, is within these ranges, a more advantageous effect is obtained from the viewpoint that a resin molded article having an elastic modulus that is high to a certain extent and having shape memory properties may be easily formed. From a similar point of view, the radical polymerizable monomers may also include a (meth)acrylate having an alkyl group with 8 or fewer carbon atoms, which may have a substituent, and the proportion of the (meth)acrylate may be in the numerical ranges described above.

Examples of the alkyl (meth)acrylate having 1 to 16 carbon atoms, which may have a substituent, include ethyl acrylate, ethyl methacrylate, n-butyl acrylate, n-butyl methacrylate, isobutyl acrylate, isobutyl methacrylate, hexyl acrylate, hexyl methacrylate, 2-ethylhexyl acrylate (EHA), 2-ethylhexyl methacrylate, 2-hydroxyethyl methacrylate, 2-hydroxypropyl methacrylate, 2-hydroxy-1-methylethyl methacrylate, 2-methoxyethyl acrylate (MEA), N,N-dimethylaminoethyl acrylate, and glycidyl methacrylate. These can be used singly or in combination of two or more kinds thereof.

When the radical polymerizable monomers include acrylonitrile, there is a tendency that a resin molded article that has excellent mechanical characteristics such as elongation and strength and excellent folding resistance, has an elastic modulus that is high to a certain extent, and has shape memory properties is easily formed. A combination of acrylonitrile and a (meth)acrylate having an alkyl group with 1 to 16 (or 1 to 10) carbon atoms is particularly advantageous for obtaining a resin molded article having a high elastic modulus. The proportion of acrylonitrile in the composition for molding may be 40 mol % or more, 50 mol % or more, or 70 mol % or more, and may be 90 mol % or less, 85 mol % or less, or 80 mol % or less, based on the total amount of the radical polymerizable monomers. When the proportion of acrylonitrile is within these ranges, a more advantageous effect is obtained in view of having rapid shape restoration.

The radical polymerizable monomers may also include one kind or two or more kinds of compounds selected from a vinyl ether, styrene, and a styrene derivative as a monofunctional radical polymerizable monomer. Examples of the vinyl ether include vinyl butyl ether, vinyl octyl ether, vinyl-2-chloroethyl ether, vinyl isobutyl ether, vinyl dodecyl ether, vinyl octadecyl ether, vinyl phenyl ether, and vinyl cresyl ether. Examples of the styrene derivative include an alkylstyrene, an alkoxystyrene (α-methoxystyrene, p-methoxystyrene, or the like), and m-chlorostyrene.

The radical polymerizable monomers may also include another monofunctional radical polymerizable monomer and/or a polyfunctional radical polymerizable monomer. Examples of the other monofunctional radical polymerizable monomer include vinyl phenol, N-vinyl carbazole, 2-vinyl-5-ethylpyridine, isopropenyl acetate, vinyl isocyanate, vinyl isobutyl sulfide, 2-chloro-3-hydroxypropene, vinyl stearate, p-vinyl benzyl ethyl carbinol, vinyl phenyl sulfide, allyl acrylate, α-chloroethyl acrylate, allyl acetate, 2,2,6,6-tetramethyl piperidinyl methacrylate, N,N-diethyl vinyl carbamate, vinyl isopropenyl ketone, N-vinyl caprolactone, vinyl formate, p-vinyl benzyl methyl carbinol, vinyl ethyl sulfide, vinylferrocene, vinyl dichloroacetate, N-vinylsuccinimide, allyl alcohol, norbornadiene, diallyl melamine, vinyl chloroacetate, N-vinylpyrrolidone, vinyl methyl sulfide, N-vinyloxazolidone, vinyl methyl sulfoxide, N-vinyl-N′-ethylurea, and acenaphthalene.

The various radical polymerizable monomers listed above as examples can be used singly or in combination of two or more kinds thereof.

The composition for molding includes the radical polymerizable monomers explained above, and a linear or branched second polymer. The second polymer may be a polymer containing two or more linear chains and linking groups that connect the terminals of the linear chains. This polymer contains, for example, a molecular chain represented by the following Formula (B). In Formula (B), R²⁰ represents a monomer unit that constitutes a linear chain; n¹, n², and n³ each independently represent an integer of 1 or greater; and L represents a linking group. A plurality of R²⁰'s and a plurality of L's in the same molecule may be respectively identical or different.

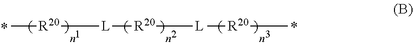

The linear chain composed of the monomer unit R²⁰ may be a molecular chain derived from a polyether, a polyester, a polyolefin, a polyorganosiloxane, or a combination thereof. The respective linear chains may be polymers, or may be oligomers.

Examples of a linear chain derived from a polyether include polyoxyalkylene chains such as a polyoxyethylene chain, a polyoxypropylene chain, a polyoxybutylene chain, and combinations thereof. The polyoxyethylene chain is derived from a polyether such as a polyalkylene glycol. Examples of a linear chain derived from a polyolefin include a polyethylene chain, a polypropylene chain, a polyisobutylene chain, and combinations thereof. Examples of a linear chain derived from a polyester include a poly-ε-caprolactone chain. Examples of a linear chain derived from a polyorganosiloxane include a polydimethylsiloxane chain. The second polymer may contain these singly or a combination of two or more kinds selected from these.

The number average molecular weight of each of the linear molecular chains that constitute the second polymer is not particularly limited; however, the number average molecular weight may be, for example, 1,000 or more, 3,000 or more, or 5,000 or more, and may be 80,000 or less, 50,000 or less, or 20,000 or less. According to the present specification, unless particularly defined otherwise, the number average molecular weight means a value that is determined by gel permeation chromatography and calculated relative to polystyrene standards.

The linking group L is an organic group containing a cyclic group, or a branched organic group. The linking group L may also be, for example, a divalent group represented by the following Formula (30).

*—Z⁵—R³⁰—Z⁶—* (30)

R³⁰ represents a cyclic group; a group containing two or more cyclic groups linked to each other directly or via an alkylene group; or a branched organic group that contains carbon atoms and may contain a heteroatom selected from an oxygen atom, a nitrogen atom, a sulfur atom, and a silicon atom. Z⁵ and Z⁶ each represent a divalent group that links R³⁰ to a linear chain, and represents a group represented by, for example, —NHC(═O)—, —NHC(═O)O—, —O—, —OC(═O)—, —S—, —SC(═O)—, —OC(═S)—, or —NR¹⁰—(wherein R¹⁰ represents a hydrogen atom or an alkyl group). According to the present specification, the terminal atoms of the linear chain (atoms originating from a monomer that constitutes the linear chain) are usually not construed as atoms that constitute Z⁵ or Z⁶. In a case in which it is not clear whether the terminal atoms of the linear chain are atoms originating from a monomer, the atoms may be construed to be included in any of a linear chain and a linking group.

The cyclic group contained in the linking group L may contain a heteroatom selected from a nitrogen atom and a sulfur atom. The cyclic group contained in the linking group L may be an alicyclic group, a cyclic ether group, a cyclic amine group, a cyclic thioether group, a cyclic ester group, a cyclic amide group, a cyclic thioester group, an aromatic hydrocarbon group, a heteroaromatic hydrocarbon group, or a combination thereof. Specific examples of the cyclic group contained in the linking group L include a 1,4-cyclohexanediyl group, a 1,2-cyclohexanediyl group, a 1,3-cyclohexanediyl group, a 1,4-benzenediyl group, a 1,3-benzenediyl group, a 1,2-benzenediyl group, and a 3,4-furandiyl group.

Examples of the branched organic group contained in the linking group L (for example, R³⁰ in Formula (30)) include a lysinetriyl group, a methylsilanetriyl group, and a 1,3,5-cyclohexanetriyl group.

The linking group L represented by Formula (30) may be a group represented by the following Formula (31). R³¹ in Formula (31) represents a single bond or an alkylene group. R³¹ may also be an alkylene group having 1 to 3 carbon atoms. Z⁵ and Z⁶ have the same definitions as Z⁵ and Z⁶ of Formula (30), respectively.

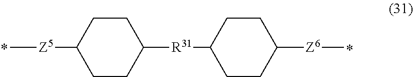

The weight average molecular weight of the second polymer is not particularly limited; however, for example, the weight average molecular weight may be 5,000 or more, 7,000 or more, or 9,000 or more, and may be 100,000 or less, 80,000 or less, or 60,000 or less. When the weight average molecular weight of the second polymer is within these numerical ranges, there is a tendency that satisfactory compatibility with components other than the second polymer and satisfactory general characteristics of the resin molded article are easily obtained.

As will be understood by those ordinarily skilled in the art, the second polymer can be obtained by a conventional synthesis method by using conventionally available raw materials as starting materials. For example, the second polymer can be synthesized by a reaction between a mixture including a polyalkylene glycol a polyester, a polyolefin, a polyorganosiloxane, which have reactive terminal groups (hydroxyl groups or the like), or a combination thereof, and a compound having a reactive functional group (an isocyanate group or the like) and a cyclic group or a branched group. The second polymer to be synthesized may also include a branched structure based on a side reaction such as trimerization of isocyanate groups.

The composition for molding may also include a polymerization initiator for polymerizing the radical polymerizable monomers. The polymerization initiator may be a thermal radical polymerization initiator, a photoradical polymerization initiator, or a combination thereof. The content of the polymerization initiator may be adjusted as appropriate in a conventional range; however, the content may be, for example, 0.01% to 5% by mass based on the mass of the composition for molding.

Examples of the thermal radical polymerization initiator include organic peroxides such as a ketone peroxide, a peroxy ketal, a dialkyl peroxide, a diacyl peroxide, a peroxy ester, a peroxy dicarbonate, and a hydroperoxide; persulfates such as sodium persulfate, potassium persulfate, and ammonium persulfate; azo compounds such as 2,2′-azobisisobutyronitrile (AIBN), 2,2′-azobis-2,4-dimethylvaleronitrile (ADVN), 2,2′-azobis-2-methylbutyronitrile, and 4,4′-azobis-4-cyanovaleric acid; alkyl metals such as sodium ethoxide and tert-butyllithium; and silicon compounds such as 1-methoxy-1-(trimethylsiloxy)-2-methyl-1-propene.

A thermal radical polymerization initiator and a catalyst may also be used in combination. Examples of this catalyst include metal salts, and reducing compounds such as a tertiary amine compound, such as N,N,N′,N′-tetramethylethylenediamine.

Examples of the photoradical polymerization initiator include 2,2-dimethoxy-1,2-diphenylethan-1-one. Commercially available products thereof include Irgacure 651 (manufactured by Ciba-Geigy Japan, Ltd.).

The composition for molding may include a solvent or may be substantially solvent-free. The composition for molding may be in any of a liquid form, a semisolid form, and a solid form. The composition for molding before being cured may be in a film form.

The resin molded article can be produced by a method including a step of producing a first polymer by radical polymerization of the radical polymerizable monomers in the composition for molding. Radical polymerization of the radical polymerizable monomers can be initiated by heating, or irradiation with active rays such as ultraviolet radiation.

The shape and size of the resin molded article (cured article) are not particularly limited, and for example, a resin molded article having an arbitrary shape can be obtained by curing the composition for molding that has been filled in a predetermined mold. The resin molded article may have, for example, a fibrous shape, a rod shape, a columnar shape, a cylindrical shape, a flat plate shape, a disc shape, a helical shape, a spherical shape, or a ring shape. The molded article obtained after curing may also be further processed by various methods such as machine processing.

The temperature of the polymerization reaction is not particularly limited; however, in a case in which the composition for molding includes a solvent, it is preferable that the temperature is lower than or equal to the boiling point of the solvent. It is preferable that the polymerization reaction is carried out in an atmosphere of an inert gas such as nitrogen gas, helium gas, or argon gas. Thereby, polymerization inhibition by oxygen is suppressed, and a molded article having satisfactory product quality can be stably obtained.

It is considered that when the radical polymerizable monomers including the radical polymerizable compound of Formula (I) are polymerized, cyclic monomer units of Formula (II) are formed. When the radical polymerizable monomers are polymerized in the presence of the first polymer, a structure in which the second polymer penetrates through the cyclic moiety in at least a portion of the cyclic monomer units of Formula (II) may be formed. The following Formula (III) schematically represents a structure in which the second polymer (B) penetrates through a cyclic moiety of a monomer unit of Formula (II) contained in the first polymer (A). R⁵ in Formula (III) is a monomer unit derived from a radical polymerizable monomer other than the radical polymerizable compound of Formula (I). When a structure such as Formula (III) is formed, a crosslinked network structure like a three-dimensional copolymer is formed by the first polymer and the second polymer. In this network structure, it is considered that the degree of freedom in motion of the second polymer that penetrates through a cyclic moiety is maintained at a relatively high level. Such a structure may be referred to as a slide-ring structure by those ordinarily skilled in the art, and the inventors of the present invention speculate that this slide-ring structure contributes to the manifestation of unique characteristics such as the shape memory properties of the resin molded article. It is not technically easy to directly confirm that a slide-ring structure has been formed; however, for example, since the stress-strain curve obtainable by a tensile test of the resin molded article is a so-called J-shaped curve, formation of the slide-ring structure is suggested. However, the resin molded article may not necessarily contain such a slide-ring structure.

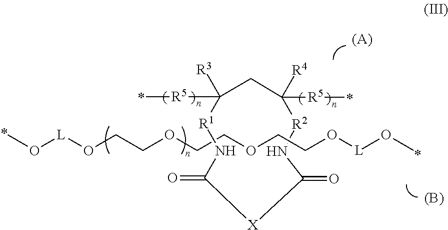

In the example of Formula (III), the second polymer (B) has a plurality of polyoxyethylene chain and a linking group L that connects a terminals of the polyoxyethylene chains. Since the linking group L is bulky compared to a polyoxyethylene chain, the state in which the second polymer penetrates through a cyclic moiety of the monomer unit of Formula (II) can be easily maintained, as in the case of a polyrotaxane. The second polymer can be selected as appropriate based on the balance in the size, inclusion ability, and the like of the cyclic monomer unit, and the characteristics of polyrotaxanes.

Although a resin molded article in which the first polymer has been produced and cured may have or may not have shape memory properties, a resin molded article having shape memory properties can be obtained by appropriately selecting the kinds of the radical polymerizable monomers. According to the present specification, the “shape memory properties” mean properties by which, when a resin molded article is deformed by an external force at room temperature (for example, 25° C.), the resin molded article retains the shape after deformation at room temperature and restores the original shape when heated to a high temperature under no-load conditions. However, the resin molded article may not perfectly restore the same shape as the original shape as a result of heating. The temperature of heating for shape restoration is, for example, 70° C.

In a case in which a cured resin molded article has shape memory properties, usually, the shape of the resin molded article possessed at the time point at which a first polymer is produced and cured becomes a basic shape. The resin molded article that has been deformed by an external force is deformed so as to approach this basic shape as a result of heating. By curing the resin molded article inside a mold having a predetermined shape, a resin molded article having a desired shape as the basic shape can be obtained.

The storage modulus at 25° C. of the resin molded article is not particularly limited; however, the storage modulus may be 0.5 MPa or higher. A resin molded article having a storage modulus of 0.5 MPa or higher typically has shape memory properties. The elastic modulus of the resin molded article may be 1.0 MPa or higher, or 10 MPa or higher, and may be 10 GPa or lower, 5 GPa or lower, or 500 MPa or lower. As the storage modulus is higher, the resin molded article tends to easily retain the shape after deformation. When the resin molded article has a storage modulus of an appropriate magnitude, the resin molded article tends to easily restore the original shape at the time of heating. The elastic modulus of the resin molded article can be controlled based on, for example, the kinds and mixing ratios of the radical polymerizable monomers, the molecular weight of the second polymer, and the amount of the radical polymerization initiator.

Photosensitive Resin Composition for Solder Resist

The photosensitive resin composition for solder resist according to an embodiment comprises Component (A): radical polymerizable monomers, Component (B): a linear or branched polymer (second polymer), and Component (C): a photopolymerization initiator. Furthermore, the photosensitive resin composition for solder resist according to an embodiment may also include, in addition to the Component (A), Component (B) and Component (C), Component (D): a sensitizing dye, Component (E): a hydrogen donor, and the like. In the following description, the various components will be described in detail. In relation to matters other than the matters described below, matters similar to those adopted in the embodiments of the composition for molding described above can also be applied to the photosensitive resin composition for solder resist.

Component (A): Radical Polymerizable Monomers (Reactive Monomers)

The radical polymerizable monomers include, similarly to the case of the composition for molding described above, a radical polymerizable compound represented by Formula (I) and a monofunctional radical polymerizable monomer. When the reactive monomers are polymerized in the photosensitive resin composition for solder resist, a first polymer composed of monomer units derived from the radical polymerizable monomers is produced. Thereby, the photosensitive resin composition for solder resist is photocured, and a solder resist (cured article) is formed. The first polymer is usually formed within the solder resist as a polymer different from the second polymer, without being bonded to the second polymer by covalent bonding.

The proportion of the radical polymerizable compound of Formula (I) in the photosensitive resin composition for solder resist may be 0.01 mol % or more, 0.1 mol % or more, or 0.5 mol % or more, and may be 10 mol % or less, 5 mol % or less, or 1 mol % or less, based on the total amount of the reactive monomers. When the proportion of the radical polymerizable compound of Formula (I) is within these ranges, a more advantageous effect is obtained from the viewpoint that a solder resist (cured article) having excellent mechanical characteristics such as flexibility and strength is obtained.

The proportion of an alkyl (meth)acrylate having 1 to 16 carbon atoms which may have a substituent, in the photosensitive resin composition for solder resist may be 10 mol % or more, 15 mol % or more, or 20 mol % or more, and may be 95 mol % or less, 90 mol % or less, or 85 mol % or less, based on the total amount of the reactive monomers. When the proportion of the alkyl (meth)acrylate having 1 to 16 carbon atoms which may have a substituent is within these ranges, a more advantageous effect is obtained from the viewpoint that a solder resist (cured article) having excellent mechanical characteristics such as flexibility and strength is obtained.

When an alkyl (meth)acrylate having an alkyl group with a small number of carbon atoms is used, the strength of the solder resist tends to increase. From such a viewpoint, the radical polymerizable monomers may also include an alkyl (meth)acrylate having an alkyl group with 10 or fewer carbon atoms which may have a substituent, as a monofunctional radical polymerizable monomer. The proportion of the alkyl (meth)acrylate having 10 or fewer carbon atoms which may have a substituent, in the photosensitive resin composition for solder resist may be 8 mol % or more, 10 mol % or more, or 15 mol % or more, and may be 55 mol % or less, 45 mol % or less, or 25 mol % or less, based on the total amount of the radical polymerizable monomers. When the proportion of the alkyl (meth)acrylate having an alkyl group with 10 or fewer carbon atoms which may have a substituent, is within these ranges, a more advantageous effect is obtained from the viewpoint that a solder resist capable of achieving a balance between flexibility and strength is likely to be formed. From a similar point of view, the radical polymerizable monomers may include a (meth)acrylate having an alkyl group with 8 or fewer carbon atoms which may have a substituent, and the proportion of the (meth)acrylate may be in the numerical range described above.

When the radical polymerizable monomers include acrylonitrile, there is a tendency that a solder resist having high strength is likely to be formed. A combination of acrylonitrile and a (meth)acrylate having an alkyl group with 1 to 16 (or 1 to 10) carbon atoms is particularly advantageous for obtaining a solder resist having satisfactory flexibility and strength. The proportion of acrylonitrile in the photosensitive resin composition for solder resist may be 40 mol % or more, 50 mol % or more, or 70 mol % or more, and may be 90 mol % or less, 85 mol % or less, or 80 mol % or less, based on the total amount of the radical polymerizable monomers. When the proportion of acrylonitrile is within these ranges, a more advantageous effect is obtained from the viewpoint of achieving a balance between flexibility and strength.

The radical polymerizable monomers may include a compound containing at least two or more units of the following partial structure:

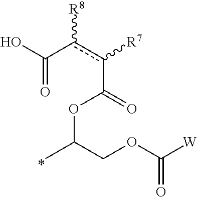

in the molecule (hereinafter, referred to as “acid-modified vinyl group-containing epoxy resin”). In the formula, the symbol: [symbol]
represents a single bond or a double bond; R⁷ and R⁸ each independently represent a hydrogen atom, an alkyl group which may have a substituent, or an alkenyl group which may have a substituent, or R⁷ and R⁸ may be linked together so as to form a ring which may have a substituent; and W represents an organic group having a radical polymerizable unsaturated group.

As will be understandable to those ordinarily skilled in the art, the acid-modified vinyl group-containing epoxy resin can be synthesized by a conventional synthesis method by using conventionally available raw materials as starting materials. For example, the acid-modified vinyl group-containing epoxy resin can be synthesized by adding a saturated or unsaturated polybasic acid anhydride (c) to an ester of an epoxy resin (a) having two or more epoxy groups in one molecule and an unsaturated group-containing monocarboxylic acid (b).

Examples of the epoxy resin (a) include novolac resins such as a phenol novolac resin and a cresol novolac type epoxy resin; a bisphenol A type epoxy resin, a bisphenol F type epoxy resin, and a hydrogenated bisphenol A type epoxy resin.

When a novolac resin is used as the epoxy resin (a), an acid-modified vinyl group-containing novolac epoxy resin is synthesized. When a bisphenol A type epoxy resin is used as the epoxy resin (a), an acid-modified vinyl group-containing bisphenol A type epoxy resin is synthesized. When a bisphenol F type epoxy resin is used as the epoxy resin (a), an acid-modified vinyl group-containing bisphenol F type epoxy resin is synthesized. When a hydrogenated bisphenol A type epoxy resin is used as the epoxy resin (a), an acid-modified vinyl group-containing hydrogenated bisphenol A type epoxy resin is synthesized.

Examples of the unsaturated group-containing monocarboxylic acid (b) include acrylic acid, a dimer of acrylic acid, methacrylic acid, β-furfuryl acrylic acid, β-styryl acrylic acid, cinnamic acid, crotonic acid, α-cyanocinnamic acid, a semi-ester compound which is a reaction product of a hydroxyl group-containing acrylate and a saturated or unsaturated dibasic acid anhydride, and a semi-ester compound which is a reaction product of an unsaturated group-containing monoglycidyl ether and a saturated or unsaturated dibasic acid anhydride. These semi-ester compounds are obtained by reacting a hydroxyl group-containing acrylate, an unsaturated group-containing monoglycidyl ether, and a saturated or unsaturated dibasic acid anhydride at an equimolar ratio. The unsaturated group-containing monocarboxylic acid (b) can be used singly or in combination of two or more kinds thereof.

Examples of the hydroxyl group-containing acrylate or unsaturated group-containing monoglycidyl ether, which is used for the synthesis of the above-mentioned semi-ester compounds, which are an example of the unsaturated group-containing monocarboxylic acid (b), include hydroxyethyl acrylate, hydroxyethyl methacrylate, hydroxypropyl acrylate, hydroxypropyl methacrylate, hydroxbutyl acrylate, hydroxybutyl methacrylate, polyethylene glycol monoacrylate, polyethylene glycol monomethacrylate, trimethylolpropane diacrylate, trimethylolpropane dimethacrylate, pentaerythritol triacrylate, pentaerythritol trimethacrylate, dipentaerythritol pentaacrylate, pentaerythritol pentamethacrylate, glycidyl acrylate, and glycidyl methacrylate. Examples of the saturated or unsaturated dibasic acid anhydride used for the synthesis of the above-mentioned semi-ester compounds include succinic anhydride, maleic anhydride, tetrahydrophthalic anhydride, phthalic anhydride, methyltetrahydrophthalic anhydride, ethyltetrahydrophthalic anhydride, hexahydrophthalic anhydride, methylhexahydrophthalic anhydride, ethylhexahydrophthalic anhydride, and itaconic anhydride.

W in the formula described above is derived from a partial structure other than the monocarboxylic acid moiety in the unsaturated group-containing monocarboxylic acid (b). Examples of W include groups represented by the following formulae.

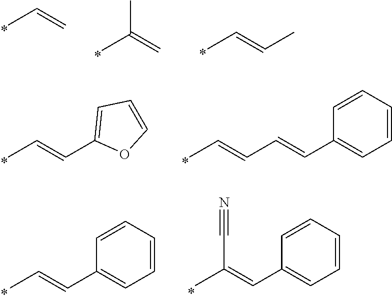

In regard to the reaction between the epoxy resin (a) and the unsaturated group-containing monocarboxylic acid (b), the amount of the unsaturated group-containing monocarboxylic acid (b) reacted with 1 equivalent of epoxy groups of the epoxy resin (a) may be 0.8 equivalents or more, or 0.9 equivalents or more, and may be 1.1 equivalents or less, or 1.0 equivalents or less.

The reaction between the epoxy resin (a) and the unsaturated group-containing monocarboxylic acid (b) can be carried out in an organic solvent. Examples of the organic solvent to be used include ketones such as ethyl methyl ketone and cyclohexanone; aromatic hydrocarbons such as toluene, xylene, and tetramethylbenzene; glycol ethers such as methyl cellosolve, butyl cellosolve, methyl carbitol, butyl carbitol, propylene glycol monomethyl ether, dipropylene glycol monoethyl ether, dipropylene glycol diethyl ether, and triethylene glycol monoethyl ether; esters such as ethyl acetate, butyl acetate, butyl cellosolve acetate, and carbitol acetate; aliphatic hydrocarbons such as octane and decane; and petroleum-based solvents such as petroleum ether, petroleum naphtha, hydrogenated petroleum naphtha, and solvent naphtha.

In order to accelerate the reaction between the epoxy resin (a) and the unsaturated group-containing monocarboxylic acid (b), a catalyst can be used. Examples of the catalyst to be used include triethylamine, benzylmethylamine, methyltriethylammonium chloride, benzyltrimethylammonium chloride, benzyltrimethylammonium bromide, benzyltrimethylammonium iodide, and triphenylphosphine. The amount of use of the catalyst is, for example, 0.1% to 10% by mass with respect to the total mass of the epoxy resin (a) and the unsaturated group-containing monocarboxylic acid (b).

In order to prevent polymerization during the reaction between the epoxy resin (a) and the unsaturated group-containing monocarboxylic acid (b), a polymerization inhibitor can also be used. Examples of the polymerization inhibitor to be used include hydroquinone, methylhydroquinone, hydroquinone monomethyl ether, catechol, and pyrogallol. The amount o fuse of the polymerization inhibitor is, for example, 0.01% to 1% by mass with respect to the total mass of the epoxy resin (a) and the unsaturated group-containing monocarboxylic acid (b).

If necessary, the unsaturated group-containing monocarboxylic acid (b) and a polybasic acid anhydride such as trimellitic anhydride, pyromellitic anhydride, benzophenonetetracarboxylic acid anhydride, or biphenyltetracarboxylic acid anhydride can be used in combination.

The reaction temperature may be 60° C. or higher or 80° C. or higher, and may be 150° C. or lower or 120° C. or lower.

Examples of the saturated or unsaturated group-containing polybasic acid anhydride (c) include succinic anhydride, maleic anhydride, tetrahydrophthalic anhydride, phthalic anhydride, methyltetrahydrophthalic anhydride, ethyltetrahydrophthalic anhydride, hexahydrophthalic anhydride, methylhexahydrophthalic anhydride, ethylhexahydrophthalic anhydride, and itaconic anhydride.

In the formulae described above, the following partial structure:

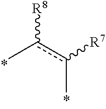

is derived from a partial structure other than the acid anhydride moiety in the saturated or unsaturated group-containing polybasic acid anhydride (c). Examples of the partial structure include structures represented by the following formulae:

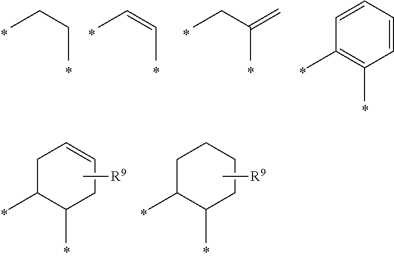

In the formulae, R⁹ represents a hydrogen atom, a methyl group, or an ethyl group.

In regard to the reaction between a reaction product of the epoxy resin (a) and the unsaturated group-containing monocarboxylic acid (b) and the saturated or unsaturated group-containing polybasic acid anhydride (c), the acid value of the acid-modified vinyl group-containing epoxy resin can be regulated by reacting 0.1 to 1.0 equivalent of the saturated or unsaturated group-containing polybasic acid anhydride (c) with 1 equivalent of hydroxyl groups in the reaction product of the epoxy resin (a) and the unsaturated group containing monocarboxylic acid. The acid value of the acid-modified vinyl group-containing epoxy resin may be 30 KOH/g or more, or 50 mg KOH/g or more, and may be 150 mg KOH/g or less, or 120 mg KOH/g or less. When the acid value is 30 mg KOH/g or more, there is a tendency that the solubility of the photosensitive resin composition for solder resist in a dilute alkali solution is not decreased. When the acid value is 150 mg KOH/g or less, there is a tendency that the electrical characteristics of the cured film are not deteriorated.

The proportion of the acid-modified vinyl group-containing epoxy resin in the reactive monomers may be 3% by mass or more, 4% by mass or more, or 5% by mass or more, and may be 70% by mass or less, 60% by mass or less, or 50% by mass or less, based on the total amount of the reactive monomers. When the proportion of the acid-modified vinyl group-containing epoxy resin is within these ranges, a more advantageous effect is obtained from the viewpoint of achieving a balance between resolution and flexibility.

Component (B): Linear or Branched Polymer (Second Polymer)

The second polymer may be a polymer containing two or more linear chains and linking groups that connect the terminals of the linear chains. This polymer contains, for example, a molecular chain represented by the following Formula (B). In Formula (B), R²⁰ represents a monomer unit that constitutes a linear chain; n¹, n², and n³ each independently represent an integer of 1 or greater; and L represents a linking group. A plurality of R²⁰'s and a plurality of L's in the same molecule may be respectively identical or different.

The weight average molecular weight of the second polymer is not particularly limited; however, for example, the weight average molecular weight may be 5,000 or more, 7,000 or more, or 9,000 or more, and may be 100,000 or less, 80,000 or less, or 60,000 or less. According to the present specification, unless particularly defined otherwise, the weight average molecular weight means a value determined by gel permeation chromatography and calculated relative to polystyrene standards. When the weight average molecular weight of the polymer is within these value ranges, there is a tendency that satisfactory compatibility with components other than the polymer, and satisfactory general characteristics of solder resist are likely to be obtained.

As will be understandable by those ordinarily skilled in the art, the second polymer can be obtained by a conventional synthesis method by using conventionally available raw materials as starting materials. For example, the polymer can be synthesized by a reaction between a polyalkylene glycol having reactive terminal groups (hydroxyl groups or the like), a polyester, a polyolefin, a polyorganosiloxane, or a mixture including a combination thereof, and a compound having a reactive functional group (isocyanate group or the like) and a cyclic group or a branched group. The polymer thus synthesized may also contain a branched structure based on a side reaction such as trimerization of isocyanate groups.

Component (C): Photopolymerization Initiator

The photopolymerization initiator is not particularly limited, and any conventionally used photopolymerization initiator can be used. Examples of the photopolymerization initiator include aromatic ketones such as benzophenone and 2-benzyl-2-dimethylamino-1-(4-morpholinophenyl)-butanone, 1,2-methyl-1-[4-(methylthio)phenyl]-2-morpholinopropanone-1,2,4-dim ethoxy-1,2-diphenylethan-1-one (Irgacure 651 (manufactured by Ciba-Geigy Japan, Ltd.)), and 2,4-diethylthioxanthone (KAYACURE DETX-S (manufactured by Nippon Kayaku Co., Ltd.)); quinone compounds such as an alkylanthraquinone; benzoin ether compounds such as a benzoin alkyl ether; benzoin compounds such as benzoin and an alkylbenzoin; benzyl derivatives such as benzyl dimethyl ketal; 2,4,5-triarylimidazole dimers such as a 2-(2-chlorophenyl)-4,5-diphenylimidazole dimer and a 2-(2-fluorophenyl)-4,5-diphenylimidazole dimer; and acridine derivatives such as 9-phenylacridine and 1,7-(9,9′-acridinyl)heptane. The photopolymerization initiators can be used singly or in combination of two or more kinds thereof.

The content of Component (C) in the photosensitive resin composition for solder resist may be 0.1% by mass or more, 1% by mass or more, 2% by mass or more, or 3% by mass or more, and may be 10% by mass or less, 7% by mass or less, 6% by mass or less, or 5% by mass or less, with respect to the total mass of Component (A) and Component (B). When the content of Component (C) is 0.1% by mass or more, satisfactory sensitivity, resolution and adhesiveness are likely to be obtained, and when the content is 10% by mass or less, a satisfactory resist shape is likely to be obtained.

Component (D): Sensitizing Dye

The photosensitive resin composition for solder resist may also include at least one sensitizing dye as Component (D). A sensitizing dye is a compound capable of effectively utilizing the absorption wavelength of active light rays used for exposure, and for example, a compound having a maximum absorption wavelength of 340 nm to 420 nm can be used.

Examples of the sensitizing dye include a pyrazoline compound, an anthracene compound, a coumarin compound, a xanthone compound, an oxazole compound, a benzoxazole compound, a thiazole compound, a benzothiazole compound, a triazole compound, a stilbene compound, a triazine compound, a thiophene compound, and a naphthalimide compound. Particularly, from the viewpoint that resolution, adhesiveness and sensitivity can be enhanced, it is preferable that the sensitizing dye contains a pyrazoline compound or an anthracene compound. The sensitizing dyes can be used singly or in combination of two or more kinds thereof.

The content of Component (D) in the photosensitive resin composition for solder resist may be 0.01% by mass or more, 0.05% by mass or more, or 0.1% by mass or more, and may be 10% by mass or less, 5% by mass or less, or 3% by mass or less, with respect to the total mass of Component (A) and Component (B). When the content of Component (D) is 0.01% by mass or more, satisfactory sensitivity, resolution, and adhesiveness are likely to be obtained, and when the content is 10% by mass or less, a satisfactory resist shape is likely to be obtained.

Component (E): Hydrogen Donor

The photosensitive resin composition for solder resist may include at least one hydrogen donor that can donate hydrogen to the photopolymerization initiator of Component (C) at the time of the reaction of an exposed portion, in order to improve the contrast between an exposed portion and an unexposed portion (also referred to as “imaging performance”). Examples of the hydrogen donor include bis[4-(dimethylamino)phenyl]methane, bis[4-(diethylamino)phenyl]methane, and Leuco Crystal Violet. The hydrogen donors can be used singly or in combination of two or more kinds thereof.

The content of Component (E) in the photosensitive resin composition for solder resist may be 0.01% by mass or more, 0.05% by mass or more, or 0.1% by mass or more, and may be 10% by mass or less, 5% by mass or less, or 2% by mass or less, with respect to the total mass of Component (A) and Component (B). When the content of Component (E) is 0.01% by mass or more, satisfactory sensitivity is likely to be obtained, and when the content is 10% by mass or less, there is a tendency that precipitation of an excess of Component (E) is suppressed after the formation of a film.

Other Components

The photosensitive resin composition for solder resist may also include, if necessary, a compound having at least one cyclic ether group capable of cationic polymerization in the molecule (oxetane compound or the like); a cationic polymerization initiator; a dye such as Malachite Green, Victoria Pure Blue, Brilliant Green, or Methyl Violet; a photocolor developer such as tribromophenylsulfone, diphenylamine, benzylamine, triphenylamine, diethylaniline, or 2-chloroaniline; a plasticizer such as p-toluenesulfonamide; a pigment; a binder polymer; a filler; an antifoaming agent; a flame retardant; a stabilizer; a tackifier; a leveling agent; a peeling accelerator; an oxidation inhibitor; a fragrance; an imaging agent; a thermal crosslinking agent; and the like. These can be used singly or in combination of two or more kinds thereof.

In a case in which the photosensitive resin composition for solder resist includes those other components, the contents of the other components may be 0.01% by mass or more, and may be 20% by mass or less, with respect to the total mass of Component (A) and Component (B).

Solution of Photosensitive Resin Composition for Solder Resist

The photosensitive resin composition for solder resist may further include, if necessary, at least one organic solvent in order to adjust the viscosity. Examples of the organic solvent to be used include alcohol solvents such as methanol and ethanol; ketone solvents such as acetone and methyl ethyl ketone; glycol ether solvents such as methyl cellosolve; ethyl cellosolve; and propylene glycol monomethyl ether; aromatic hydrocarbon solvents such as toluene; and aprotic polar solvents such as N,N-dimethylformamide. The organic solvents may be used singly or in combination of two or more kinds thereof. The content of the organic solvent incorporated in the photosensitive resin composition for solder resist can be selected as appropriate according to the purpose and the like. For example, the photosensitive resin composition for solder resist can be used as a solution having a solid content (components other than the organic solvent) of about 30% by mass to 60% by mass. Hereinafter, a photosensitive resin composition for solder resist including an organic solvent is also referred to as “coating liquid”.

A photosensitive layer containing a photosensitive resin composition for solder resist can be formed by applying the coating liquid mentioned above on the surface of a support that will be described below, and drying the coating liquid.

The thickness of the photosensitive layer thus formed is not particularly limited and can be selected as appropriate according to the use application. For example, the thickness can be adjusted to 1 to 100 μm as a thickness after being dried.

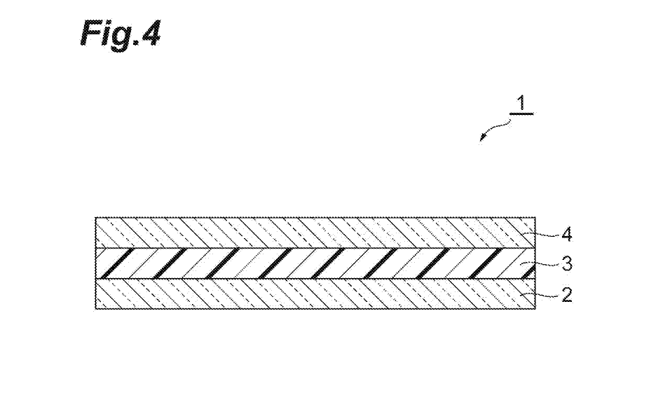

Photosensitive element FIG. 4 illustrates an embodiment of a photosensitive element. The photosensitive element 1 illustrated in FIG. 1 includes a support 2, and a photosensitive layer 3 provided on the support 2, the photosensitive layer containing the aforementioned photosensitive resin composition. The photosensitive layer 3 may be a coating film. A coating film as used in the present specification is a film in which the photosensitive resin composition for solder resist is in an uncured state. The photosensitive element 1 may also include a protective layer 4 that covers a surface of the photosensitive layer 3, the surface being on the opposite side from the support 2.

Regarding the support, a polymer film having heat resistance and solvent resistance, which is formed from a polyester such as polyethylene terephthalate; or a polyolefin such as polypropylene or polyethylene, can be used. Also, a metal plate can be used as the support. The metal plate is not particularly limited; however, examples include metal plates of copper, a copper-containing alloy, nickel, chromium, iron, and an iron-containing alloy such as stainless steel (preferably, a metal plate of copper, a copper-containing alloy, an iron-containing alloy, or the like).

The thickness of the support may be 1 μm or more, or 5 μm or more, and may be 100 μm or less, 50 μm or less, or 30 μm or less. When the thickness of the support is 1 μm or more, the support being destroyed when the support is detached can be suppressed. Furthermore, when the thickness of the support is 100 μm or less, a decrease in resolution is suppressed.

The thickness of the photosensitive layer may be, as a thickness after being dried, 1 μm or more, or 5 μm or more, and may be 100 μm or less, 50 μm or less, or 40 μm or less. When the thickness of the photosensitive layer is 1 μm or more, industrial coating is facilitated. Furthermore, when the thickness of the photosensitive layer is 100 μm or less, there is a tendency that sufficient adhesiveness and resolution are obtained.

The transmittance to ultraviolet radiation of the photosensitive layer may be 5% or higher, 10% or higher, or 15% or higher, and may be 75% or lower, 65% or lower, or 55% or lower, with respect to ultraviolet radiation in the wavelength range of 350 nm to 420 nm. When the transmittance is 5% or higher, there is a tendency that sufficient adhesiveness is likely to be obtained. When the transmittance is 75% or lower, there is a tendency that sufficient resolution is likely to be obtained. Meanwhile, the transmittance can be measured using a TN spectrometer. An example of the UV spectrometer may be 228A type W-beam spectrophotometer manufactured by Hitachi, Ltd.

Regarding the protective layer, the adhesive force for the photosensitive layer may be lower than the adhesive force of the support for the photosensitive layer. The protective layer may also be a low-fisheye film. Here, “fisheye” means that when a material is thermally melted and a film is produced by kneading, extrusion, biaxial extrusion, casting or the like, foreign materials of the material, undissolved materials, oxidative degradation products and the like have been incorporated into the film. That is, “low-fisheye” means that the amount of foreign materials and the like in the film is small.

As the protective layer, for example, a film of a polymer having heat resistance and solvent resistance, such as a polyester such as polyethylene terephthalate; or a polyolefin such as polypropylene or polyethylene, can be used. Examples of commercially available products include ALPHAN MA-410 and E-200 manufactured by Oji Holdings Corp.; polypropylene films manufactured by Shin-Etsu Chemical Co., Ltd., and the like; and polyethylene terephthalate films of PS series such as PS-25 manufactured by DuPont Teijin Films, Ltd. The protective layer may be the same material as the support.

The thickness of the protective layer may be 1 μm or more, 5 μm or more, or 15 μm or more, and may be 100 μm or less, 50 μm or less, or 30 μm. In a case in which the thickness of the protective layer is 1 μm or more, when a photosensitive layer and a support are laminated on a substrate while the protective layer is peeled off, the protective layer being destroyed can be suppressed. When the thickness of the protective layer is 100 μm or less, excellent handleability and inexpensiveness are obtained.

The photosensitive element 1 illustrated in FIG. 4 can be produced, for example, as follows. Specifically, a photosensitive element can be produced by a method including 1) a step of preparing a coating liquid in which a photosensitive resin composition for solder resist is dissolved in an organic solvent; 2) a step of applying the coating liquid on a support 2 and forming a coating layer; 3) a step of drying the coating layer to form a photosensitive layer 3; and 4) a step of covering, if necessary, a surface of the photosensitive layer 3, the surface being on the opposite side from the support 2, with a protective layer 4.

Application of the photosensitive resin composition for solder resist on the support can be carried out by any known method such as roll coating, comma coating, gravure coating, air knife coating, die coating, or bar coating.

Drying of the coating layer is not particularly limited as long as at least a portion of the organic solvent can be removed from the coating layer, and for example, drying may be performed at 70° C. to 150° C. for 5 minutes to 30 minutes. The amount of residual organic solvent in the photosensitive layer after drying may be, for example, 2% by mass or less, from the viewpoint of preventing diffusion of the organic solvent in the subsequent processes.

The photosensitive element may further have intermediate layers such as a cushion layer, an adhesive layer, a light absorbing layer, and a gas barrier layer. Regarding these intermediate layers, for example, the intermediate layers described in Japanese Unexamined Patent Publication No. 2006-098982 are applicable.

The form of the photosensitive element is not particularly limited. For example, the photosensitive element may be in a sheet form, or may being in the form of being wound around a core into a roll. In a case in which the photosensitive element is in the form of being rolled around a core into a roll, the photosensitive element may also be in the form of being wound such that the support comes on the outer side. Examples of the core include plastics such as a polyethylene resin, a polypropylene resin, a polystyrene resin, a polyvinyl chloride resin, and an ABS resin (acrylonitrile-butadiene-styrene copolymer). At the end faces of the roll-shaped photosensitive element roll thus obtained, end-face separators can be installed from the viewpoint of protecting the end faces, and moisture-proof end-face separators can be installed from the viewpoint of resistance to edge fusion. Regarding the packing method, for example, the photosensitive element roll can be wrapped with a black sheet having low moisture permeability.

### EXAMPLES

Hereinafter, the present invention will be more specifically described by way of Examples. However, the present invention is not intended to be limited to these Examples.

### Composite Material

### 1. Synthesis of Polymer Containing Polyoxyalkylene Chain (Modifying Polymer)

750 mg of a polyethylene glycol having a number average molecular weight of 1,500 and 2,000 mg of a polypropylene glycol having a number average molecular weight of 4,000 were introduced into a 20-ml pear-shaped flask, and then the interior of the flask was purged with nitrogen. The content was melted at 115° C. 4,4′-Dicyclohexylmethane diisocyanate (262 mg, 1.00 mmol) was added to the molten liquid, and the molten liquid was stirred for 24 hours at 115° C. in a nitrogen atmosphere. Thus, a modifying polymer containing a polyoxyethylene chain and a polyoxypropylene chain was obtained.

A GPC chromatogram of the resulting polymer was obtained using DMF (N,N-dimethylformamide) containing 10 mM of lithium bromide as an eluent, under the conditions of a flow rate of 1 mL/min. The number average molecular weight Mn of the polymer was determined from the resulting chromatogram, as a value calculated relative to polystyrene standards. The number average molecular weight Mn of the polymer was 50,000.

### 2. Production of Curable Resin Composition

Various components were mixed at the mixing ratios indicated in Table 1, and thereby curable resin compositions of Blending Examples 1 to 4 were produced.

### 3. Measurement of Elongation at Break and Tensile Elastic Modulus

The resulting curable resin composition was dropped on a polyethylene terephthalate (PET) film that had been subjected to a release treatment, and thereby a coating film of the curable resin composition was formed. While leaving a gap of 0.2 mm from the coating film, the coating film was covered with a PET film that had been subjected to a release treatment. The coating film was cured by irradiating the coating film with ultraviolet radiation at 365 nm from above the PET film at a cumulative amount of light of 1,000 mJ/cm², and thereby a cured product film was formed.

A specimen having a size of 5 mm×50 mm was punched out from the cured product film. In an area of the specimen corresponding to the chuck distance, marks were made with an oily marker at three sites along the longitudinal direction, and the distances between the various marks were designated as L0 and L0′. A tensile test was performed using a tensile testing machine (manufactured by Shimadzu Corp., EZ-TEST) under the conditions of a measurement temperature of 25° C., a tensile rate of 10 mm/min, and a distance between chucks L1 of 30 mm. For the specimen obtained immediately after fracture, marks at two points where there was no site of fracture between marks were selected from among the three marks, and the distance between those marks L2 was measured. In a case in which the initial length corresponding to this portion was L0, the elongation at break was calculated by formula: (L2−L0)/L0. Alternatively, the elongation at break may also be calculated by formula: (L3−L1)/L1, using the distance between chucks L3 at the time of fracture. The gradient of a stress-strain curve in the early stage of pulling was designated as the tensile modulus.

TABLE 1

| | | Blending Example | | | |
|---|---|---|---|---|---|
| | | 1 | 2 | 3 | 4 |
| First monofunctional | 2-Ethylhexyl acrylate | 48 | 75 | 38 | 48 |
| radical polymerizable | | | | | |
| monomer | | | | | |
| Second monofunctional | Acrylonitrile | 48 | — | — | 48 |
| radical polymerizable | Dicyclopentanyl acrylate | — | 22 | — | — |
| monomer | Methyl methacrylate | — | — | 58 | — |
| Bifunctional radical | 1,9-Bis(acryloyloxy)nonane | 2 | — | 2 | 2 |
| polymerizable monomer | | | | | |

| First radical polymerizable monomer content | | 49 | 77 | 41 | 56 |
|---|---|---|---|---|---|
| (mass %) | | | | | |
| Second radical polymerizable monomer content | | 49 | 23 | 57 | 42 |
| (mass %) | | | | | |
| Modifying polymer | | — | — | — | 2 |
| Photoradical | Irgacure 651 | 3 | 3 | 3 | 3 |
| polymerization | | | | | |
| initiator | | | | | |

| | | | | |
|---|---|---|---|---|
| Elongation at break (%) | 310 | 410 | 210 | 380 |
| Tensile modulus (%) | 540 | 480 | 120 | 380 |

### 4. Production of Composite Material Having Protective Material

### Example 1

The curable resin composition of Blending Example 1 was dropped on the surface of a SUS304 plate, and thereby a coating film of the curable resin composition was formed. While leaving a gap of 0.2 mm from the coating film, the coating film was covered with a PET film that had been subjected to a release treatment. The coating film was cured by irradiating the coating film with ultraviolet radiation at 365 nm from above the PET film at a cumulative amount of light of 1,000 mJ/cm², and thereby a protective material was formed on the SUS304 plate.

### Example 2

A protective material was formed on an Alloy 42 plate in the same manner as in Example 1, except that the curable resin composition of Blending Example 1 was dropped on the surface of an Alloy 42 plate.

### Example 3

A protective material was formed on a copper foil in the same manner as in Example 1, except that the curable resin composition of Blending Example 1 was dropped on a copper foil face of a copper foil-attached polyimide film (ESPANEX, trade name).

### Example 4

A copper foil pattern in the form of lines with a US ratio of 100 μm/100 μm was formed by processing the copper foil of a copper foil-attached polyimide film by photolithography. A protective material was formed on the polyimide film and the copper foil pattern in the same manner as in Example 1, except that the curable resin composition of Blending Example 1 was dropped on the copper foil pattern side of the copper foil-attached polyimide film.

### Example 5

A protective material was formed on an aluminum plate in the same manner as in Example 1, except that the curable resin composition of Blending Example 2 was dropped on the surface of an aluminum plate.

### Example 6

A protective material was formed on a tinned plate in the same manner as in Example 1, except that the curable resin composition of Blending Example 3 was dropped on the surface of a tinned plate.

### Example 7

A protective material was formed on a SUS304 plate in the same manner as in Example 1, except that the curable resin composition of Blending Example 3 was dropped on the surface of a SUS304 plate.

### Example 8

A protective material was formed on an Alloy 42 plate in the same manner as in Example 1, except that the curable resin composition of Blending Example 4 was dropped on the surface of an Alloy 42 plate.

### Comparative Example 1

A styrene-based film (STYROPHANE TRF (trade name), manufactured by Oishi Sangyo Co., Ltd.) was laminated as a protective material on a SUS304 plate.

### Comparative Example 2

A copper foil pattern in the form of lines with a L/S ratio of 100 μm/100 μm was formed by processing the copper foil of a copper foil-attached polyimide film by photolithography. A styrene-based film similar to that of Comparative Example 1 was laminated as a protective material on the copper foil pattern side of the copper foil-attached polyimide film.

### Comparative Example 3

A protective material was formed on a SUS plate by applying a urethane-based coating material (FINE URETHANE U100 (trade name), manufactured by Nippon Paint Co., Ltd.) on a SUS304 plate and drying the coating film.

### Comparative Example 4

A copper foil pattern in the form of lines with a L/S ratio of 100 μm/100 μm was formed by processing the copper foil of a copper foil-attached polyimide film by photolithography. A urethane-based coating material was applied on the copper foil pattern side of the copper foil-attached polyimide film, the coating film was dried, and thereby a protective material was formed on the polyimide film and the copper foil pattern.

### 5. Evaluation of Foldability

Various composite materials were folded at 90 degrees or 150 degrees by winding around a 1-mm shaft, with the protective material coming on the outer side. The presence or absence of cracking and peeling in the protective material after folding was checked by visual inspection. A protective material in which any change in the external appearance or abnormalities such as whitening, voids, peeling, and cracks were not seen was rated as “good”; and a protective material in which whitening, voids, peeling, and cracks were recognized was rated as “defective”.

### 6. Evaluation of Scratch Resistance

The presence or absence of scratch in a protective material at a drop point at which an iron ball weighing 10 g was dropped from a height of 50 cm perpendicularly to the face of the protective material of a composite material was observed by visual inspection. A case in which no scratch was seen in the protective material and the metal was rated as A; a case in which there was a dent in the protective material while there was a dent in the metal, was rated as B; and a case in which there was a dent in the metal was rated as C.

### 7. Evaluation of Moisture-Proofing Properties

A composite material was placed in a constant-temperature constant-humidity tank at 80° C. and 90%, and the composite material was left to stand for 192 hours. Subsequently, the state of the composite material was observed by visual inspection, and a composite material in which there was no change in the external appearance was rated as A; and a protective material in which abnormalities such as detachment of the protective material and corrosion of the metal were seen, was rated as C.

TABLE 2

| | Ex. 1 | Ex. 2 | Ex. 3 | Ex. 4 | Ex. 5 | Ex. 6 |
|---|---|---|---|---|---|---|
| Metal | SUS304 | Alloy 42 | Copper | Copper | Aluminum | Tinned |
| material | | | foil- | foil | plate | plate |
| | | | attached | pattern/ | | |
| | | | polyimide | polyimide | | |
| | | | film | film | | |
| Protective | Blending | Blending | Blending | Blending | Blending | Blending |
| material | Example 1 | Example 1 | Example 1 | Example 1 | Example 2 | Example 3 |
| Thickness | 200 | 200 | 100 | 100 | 200 | 200 |
| of | | | | | | |
| protective | | | | | | |
| material | | | | | | |
| (μm) | | | | | | |
| 90-degree | Good | Good | Good | Good | Good | Good |
| foldability | | | | | | |
| 150-degree | Good | Good | Good | Good | Good | Good |
| foldability | | | | | | |
| Scratch | A | A | A | A | A | A |
| resistance | | | | | | |
| Moisture- | A | A | A | A | A | A |
| proofing | | | | | | |
| properties | | | | | | |

TABLE 3

| | | | Comp. | Comp. | Comp. | Comp. |
|---|---|---|---|---|---|---|
| | Ex. 7 | Ex. 8 | Ex. 1 | Ex. 2 | Ex. 3 | Ex. 4 |
| Metal | SUS304 | Alloy 42 | SUS304 | Copper | SUS304 | Copper |
| material | | | | foil | | foil |
| | | | | pattern/ | | pattern/ |
| | | | | polyimide | | polyimide |
| | | | | film | | film |
| Protective | Blending | Blending | Styrene- | Styrene- | Urethane- | Urethane- |
| material | Example 4 | Example 4 | based | based | based | based |
| | | | film | film | coating | coating |
| | | | | | material | material |
| Thickness | 200 | 200 | 100 | 100 | 100 | 100 |
| of | | | | | | |
| protective | | | | | | |
| material | | | | | | |
| (μm) | | | | | | |
| 90-degree | Good | Good | Defective | Defective | Good | Good |
| foldability | | | (crack) | (crack) | | |
| 150-degree | Good | Good | Defective | Defective | Defective | Defective |
| foldability | | | (peeling) | (peeling) | (crack) | (crack) |
| Scratch | A | A | A | A | B | B |
| resistance | | | | | | |
| Moisture- | A | A | C | C | A | A |
| proofing | | | | | | |
| properties | | | | | | |

Table 2 and Table 3 show the combinations of the metal material and the protective material in the composite materials thus produced, and the evaluation results for the composite materials. In regard to the composite materials of various Examples, it was confirmed that the protective materials exhibited excellent folding resistance, scratch resistance, and moisture-proofing properties.

### Composition for Molding

### 1. Synthesis

### Synthesis Example 1: Synthesis of trans-1,2-bis(2-acryloyloxyethylcarbamoyloxy)cyclohexane (BACH)

Trans-1,2-cyclohexanediol (2.32 g, 20.0 mmol) was introduced into a 100-mL double-necked pear-shaped flask, and the interior of the flask was purged with nitrogen. Dichloromethane (40 mL) and dibutyltin dilaurate (11.8 μL, 0.10 mol %: 0.020 mmol) were introduced into the flask. To the reaction liquid in the flask, a dichloromethane (4 mL) solution of 2-acryloyloxyethyl isocyanate (5.93 g, 42.0 mmol) was added dropwise from a dropping funnel, and the reaction liquid was stirred for 24 hours at 30° C. to cause a reaction to proceed. After completion of the reaction, diethyl ether was added to the reaction liquid, and the mixture was washed with saturated brine. The organic layer was dried over anhydrous magnesium sulfate, and then the solvent was distilled off under reduced pressure. A solution containing the intended product was isolated from the residue by silica gel chromatography (developing solvent: chloroform), and the solution was concentrated. A crude product thus obtained was purified by recrystallization from diethyl ether and hexane, and thus white crystals of BACH were obtained. The yield amount was 3.78 g, and the yield percentage was 47.4% by mass.

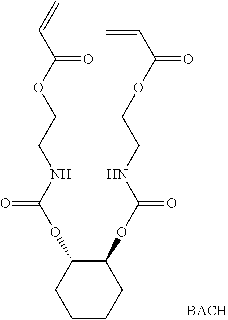 [SMILES: C=CC(=O)OCCNC(=O)O[C@H]1CCCC[C@@H]1OC(=O)NCCOC(=O)C=C]

### Synthesis Example 2: Synthesis of PEG-PPG Oligomer 1

A polyethylene glycol (PEG1500, 750 mg, 0.500 mmol, number average molecular weight 1,500) and a polypropylene glycol (PPG4000, 2,000 mg, 0.500 mmol, number average molecular weight 4,000) were added to a 20-mL pear-shaped flask, and then the interior of the flask was purged with nitrogen. The content was melted at 115° C. 4,4′-Dicyclohexylmethane diisocyanate (262 mg, 1.00 mmol) was added to the molten liquid, and the molten liquid was stirred for 24 hours at 115° C. in a nitrogen atmosphere. Thus, PEG-PPG Oligomer 1 (second polymer containing polyoxyethylene chains and polyoxypropylene chains) was obtained.

The weight average molecular weight (Mw) of resulting Oligomer 1 was 9,300, and the weight average molecular weight/number average molecular weight (Mw/Mn) of Oligomer 1 was 1.65.

### Synthesis Example 3: Synthesis of PEG-PPG Oligomer 2

A polyethylene glycol (PEG1500, 750 mg, 0.500 mmol, number average molecular weight 1,500) and a polypropylene glycol (PPG4000, 2,000 mg, 0.500 mmol, number average molecular weight 4,000) were added to a 20-mL pear-shaped flask, and then the interior of the flask was purged with nitrogen. The content was melted at 115° C. 4,4′-Dicyclohexylmethane diisocyanate (262 mg, 1.00 mmol) and dibutyltin laurate (11.8 μL, 0.10 mol %: 0.020 mmol) were added to the molten liquid, and the molten liquid was stirred for 24 hours at 115° C. in a nitrogen atmosphere. Thus, PEG-PPG Oligomer 2 (second polymer having polyoxyethylene chains and polyoxypropylene chains) was obtained.

The weight average molecular weight (Mw) of Oligomer 2 thus obtained was 50,000, and the weight average molecular weight/number average molecular weight (Mw/Mn) of Oligomer 2 was 1.95.

### 2. Measurement of Molecular Weight

A GPC chromatograph of an oligomer was obtained by using DMF (N,N-dimethylformamide) containing lithium bromide at a concentration of 10 mM as an eluent, under the conditions of a flow rate of 1 mL/min. From the chromatogram thus obtained, the number average molecular weight and the weight average molecular weight of the oligomer were determined as values calculated relative to polystyrene standards.

### Composition for Molding and Resin Molded Article

### Example 2-1

BACH of Synthesis Example 1 (27.7 mg, 69.5 μmol), PEG-PPG Oligomer 1 of Synthesis Example 2 (34.5 mg, 2.88 μmol), 2-ethylhexyl acrylate (2-EHA, 553 mg, 3.00 mmol), acrylonitrile (AN, 390 mg, 3.00 mmol), and Irgacure 651 (15.5 mg, 60.5 μmol) were heated and dissolved in a sample bottle, and thus a mixed liquid (composition for molding) was produced.

The resulting mixed liquid was poured into a stainless steel metal mold having a dimension of length×width×depth of 46 mm×10 mm×1 mm, and the metal mold was covered with a transparent sheet made of polyethylene terephthalate. The mixed liquid was photocured by irradiating the mixed liquid with UV (ultraviolet radiation) at room temperature (25° C.; hereinafter, the same) from above the transparent sheet for 30 minutes, and thus a film-shaped molded article was obtained.

A tube made of polytetrafluoroethylene (trade name: NAFLON (registered trademark) BT tube 1/8B) having an inner diameter of 1.59 mmϕ, an outer diameter of 3.17 mmϕ, and a thickness of 0.79 mm was twined around a stainless steel tube having an outer form of 10 mmϕ. The twined tube was filled with the mixed liquid, and the mixed liquid in the tube was photocured by irradiating the mixed liquid with ultraviolet radiation for 30 minutes at room temperature. Subsequently, a spiral-shaped molded article was taken out from the tube.

The mixed liquid filled in a cup-shaped mold made of polyethylene was photocured by irradiating the mixed liquid with ultraviolet radiation for 30 minutes at room temperature. A cup-shaped molded article was taken out from the mold as a molded article having a three-dimensional shape.

### Reference Example

A mixed liquid was produced in the same manner as in Example 1, except that PEG-PPG Oligomer 1 was not used. Resin molded articles of various shapes were produced in the same manner as in Example 2-1, using the mixed liquid thus obtained.

### Examples 2-2 and 2-3, and Comparative Example 2-1

Mixed liquids were produced at the mixing ratios indicated in Table 4. Resin molded articles of various shapes were produced in the same manner as in Example 2-1, using the mixed liquid thus obtained.

### 4. Evaluation: Storage Modulus

A short strip-shaped specimen having a width of 5 mm and a length of 30 mm was cut out from a film-shaped molded article. Using this specimen, the storage modulus at 25° C. was measured with a dynamic viscoelasticity analyzer (RSA-G2) manufactured by TA Instruments, Inc. The measurement conditions were as follows.
Distance between chucks: 20 mm
Measurement frequency: 10 Hz
Rate of temperature increase: 5° C./min

Shape Memory Properties

A film-shaped molded article was folded two times, and while in that state, the folds were pressed with a glass tube. It was confirmed that the folded shape substantially did not return to the original shape. A spiral-shaped molded article was extended and deformed into a rod shape. A cup-shaped molded article was deformed by interposing the molded article between two sheets of glass plates and pressing the molded article in the height direction. A case in which the molded article having various shapes retained the shape after deformation was considered as “good”, and a case in which the shape was not retained was considered as “defective”.

Thereafter, the deformed molded article was immersed in water at 70° C., and it was confirmed by visual inspection that the molded article restored the initial shape within 10 seconds from immediately after immersion. A case in which the molded article restored the initial shape was considered as “good”, and a case in which the molded article did not restore the initial shape was considered as “defective”.

Folding Resistance

In regard to the film-shaped molded articles of Examples, folded portions were restored to the original state, and then those portions were observed by visual inspection and with an optical microscope (100 times). Compared to the state before being folded, a case in which there was no change in the external appearance was considered as “good”, and a case in which abnormalities such as whitening and voids occurred was considered as “defective”.

Measurement of Strength at Break and Elongation at Break

A polyethylene terephthalate (PET) film was spread in a stainless steel metal mold having a dimension of length×width×depth of 46 mm×10 mm×1 mm. A resin composition was poured thereinto, and the metal mold was covered with a transparent sheet made of PET on the resin composition. The resin composition was irradiated with ultraviolet radiation at a dose of 2,000 mJ/cm² from above the transparent sheet at room temperature (25° C.; hereinafter, the same), and thus a resin film was obtained.

A short strip-shaped specimen (width: 8 mm, thickness: 1 mm) was cut out from the resin film thus obtained. This specimen was used to measure the strength at break and the elongation at break using a STROGRAPH T (manufactured by Toyo Seiki Seisakusho Co., Ltd.) under the conditions of room temperature, a distance between chucks of 30 mm, and a tensile rate of 10.0 mm/min.

TABLE 4

| | | Example | Example | Example | Reference | Comparative |
|---|---|---|---|---|---|---|
| | | 2-1 | 2-2 | 2-3 | Example | Example 2-1 |
| First polymer | BACH | 69.5 μmol | 69.5 μmol | 69.5 μmol | 69.5 μmol | 69.5 μmol |
| | 2-Ethylhexyl | 3.00 mmol | 2.00 mmol | 3.00 mmol | 3.00 mmol | — |
| | acrylate | | | | | |
| | Lauryl methacrylate | — | — | — | — | 5.00 mmol |
| | Acrylonitrile | 3.00 mmol | 4.00 mmol | 3.00 mmol | 3.00 mmol | 1.00 mmol |
| Second polymer | Oligomer 1 | 2.88 μmol | 2.88 μmol | — | — | 2.88 μmol |
| PEG-PPG | Oligomer 2 | — | | 2.88 μmol | — | — |
| oligomer | | | | | | |
| Storage modulus | | 1.4 MPa | 10 MPa | 4.0 MPa | 1.2 MPa | 0.1 MPa |
| Film-shaped | Shape retainability | Good | Good | Good | Good | Good |
| molded article | Shape restorability | Good | Good | Good | Defective | Defective |
| Spiral-shaped | Shape retainability | Good | Good | Good | Good | Defective |
| molded article | Shape restorability | Good | Good | Good | Defective | Defective |
| Cup-shaped | Shape retainability | Good | Good | Good | Good | Defective |
| molded article | Shape restorability | Good | Good | Good | Good | Defective |

| | | | | | |
|---|---|---|---|---|---|
| Folding resistance | Good | Good | Good | Defective | Defective |
| Strength at break | 20 MPa | 25 MPa | 20 MPa | 20 MPa | 1 MPa |
| Elongation at break | 250% | 210% | 180% | 70% | 170% |

The resin molded articles of various Examples had excellent folding resistance and exhibited high elongation percentages. Furthermore, the resin molded articles of various Examples had satisfactory shape memory properties. From these results, it was confirmed that according to an aspect of the present invention, a resin molded article having shape memory properties, which exhibited excellent heating-induced shape restorability, is obtained.

### Photosensitive Resin Composition for Solder Resist

### 1. Synthesis

### Synthesis Example 3-L: Synthesis of trans-1,2-bis(2-acryloyloxyethylcarbamoyloxy)cyclohexane (BACH)

Trans-1,2-cyclohexanediol (2.32 g, 20.0 mmol) was introduced into a 100-mL double-necked pear-shaped flask, and the interior of the flask was purged with nitrogen. Dried dichloromethane (40 mL) and dibutyltin dilaurate (11.8 μL, 0.10 mol %: 0.020 mmol) were introduced into the flask. To the reaction liquid in the flask, a dichloromethane (4 mL) solution of 2-acryloyloxyethyl isocyanate (5.93 g, 42.0 mmol) was added dropwise from a dropping funnel, and the reaction liquid was stirred for 24 hours at 30° C. to cause a reaction to proceed. After completion of the reaction, diethyl ether was added to the reaction liquid, and the mixture was washed with saturated brine. The organic layer was dried over anhydrous magnesium sulfate, and then the solvent was distilled off under reduced pressure. The residue was dissolved in acetonitrile, and a solution thus obtained was washed three times with hexane. The solvent was distilled off under reduced pressure, the residue was purified by recrystallization from a mixed solvent of diethyl ether and hexane, and thereby white crystals of BACH were obtained. The yield amount was 5.1 g, and the yield was 64% by mass.

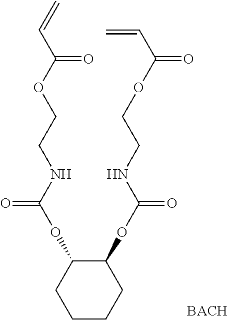 [SMILES: C=CC(=O)OCCNC(=O)O[C@H]1CCCC[C@@H]1OC(=O)NCCOC(=O)C=C]

### Synthesis Example 3-2: Synthesis of PEG-PPG Oligomer

A polyethylene glycol (PEG1500, 750 mg, 0.500 mmol, number average molecular weight: 1,500) and a polypropylene glycol (PPG4000, 2,000 mg, 0.500 mmol, number average molecular weight 4,000) were added to a 20-mL pear-shaped flask, and then the interior of the flask was purged with nitrogen. The content was melted at 115° C. 4,4′-Dicyclohexylmethane diisocyanate (262 mg, 1.00 mmol) was added to the molten liquid, and the molten liquid was stirred for 24 hours at 115° C. in a nitrogen atmosphere. Thus, a PEG-PPG oligomer (second polymer containing polyoxyethylene chains and polyoxypropylene chains) was obtained.

A GPC chromatogram of the PEG-PPG oligomer was obtained under the conditions of a flow rate of 1 mL/min, using DMF (N,N-dimethylformamide) containing 10 mM lithium bromide as an eluent. From the resulting chromatogram, the number average molecular weight and the weight average molecular weight of the PEG-PPG oligomer were determined as values calculated relative to polystyrene standards. The weight average molecular weight (Mw) of the PEG-PPG oligomer was 9,300, and the weight average molecular weight/number average molecular weight (Mw/Mn) of the PEG-PPG oligomer was 1.65.

### Synthesis Example 3-3: Synthesis of Acid-Modified Vinyl Group-Containing Bisphenol A Type Epoxy Resin

Into a flask equipped with a stirrer, a reflux cooler and a thermometer, 1052 parts by mass of a bisphenol A type epoxy resin (epoxy equivalent: 526), 144 parts by mass of acrylic acid, 1 part by mass of methylhydroquinone, 850 parts by mass of carbitol acetate, and 100 parts by mass of solvent naphtha were introduced, and the mixture was stirred at 70° C. to dissolve the mixture. The solution thus obtained was cooled to 50° C., and then 2 parts by mass of triphenylphosphine and 75 parts by mass of solvent naphtha were introduced thereinto. The mixture was allowed to react at 100° C., until the solid content acid value reached 1 mg KOH/g or less. The resulting solution was cooled to 50° C., and 745 parts by mass of tetrahydrophthalic anhydride, 75 parts by mass of carbitol acetate, and 75 parts by mass of solvent naphtha were introduced thereinto. The mixture was allowed to react for a predetermined time at 80° C., and thus a solution of an acid-modified vinyl group-containing bisphenol A type epoxy resin (solid content acid value: 80 mg KOH/g, solid content: 62% by mass) was obtained.

### 2. Photosensitive Resin Composition for Solder Resist

BACH of Synthesis Example 3-1, the PEG-PPG oligomer of Synthesis Example 3-2, the acid-modified vinyl group containing bisphenol A type epoxy resin of Synthesis Example 3-3, acrylonitrile, 2-ethylhexyl acrylate, barium sulfate, silica, talc, 1,3,5-triglycidyl isocyanurate, Irgacure 651, and KAYACURE DETX-S were mixed at the mass ratios indicated in Table 5, and the mixture was kneaded with a three-roll mill. Thus, photosensitive resin compositions for solder resist of Examples and Comparative Examples were produced.

### 3. Evaluation of Resolution

A photosensitive resin composition for solder resist thus obtained was applied on a flexible substrate by a screen printing method, with a 120-mesh TETRON screen so as to obtain a thickness (after being dried) of about 30 μm. The coating film was dried in a hot air circulation type dryer at 80° C. for 30 minutes, and thus a photosensitive layer was formed. A photo tool having a wiring pattern with a ratio of line width/space width of 30/30 to 200/200 (unit: μm) was closely adhered to the photosensitive layer as a negative, and the photosensitive layer was irradiated with ultraviolet radiation at a cumulative amount of exposure of 500 mJ/cm². The photosensitive layer was developed for 60 seconds using a 1% aqueous solution of sodium carbonate. The resolution was evaluated based on the smallest value (unit: μm) of the space width between line widths, by which a rectangular resist shape was obtained by a developing treatment. As this value is smaller, it is implied that the resolution is superior.

### 4. Evaluation of Photosensitivity

The photosensitive resin composition for solder resist thus obtained was applied on a flexible substrate by a screen printing method, with a 120-mesh Tetron screen so as to obtain a thickness (after being dried) of about 30 μm. The coating film was dried in a hot air circulation type dryer for 30 minutes at 80° C., and thereby a photosensitive layer was formed. Step Tablet 21 Steps (manufactured by Stouffer Industries, Inc.) was closely adhered to the photosensitive layer, and the photosensitive layer was irradiated with ultraviolet radiation at a cumulative amount of exposure of 500 mJ/cm². The photosensitive layer was developed for 60 seconds using a 1% aqueous solution of sodium carbonate. The photosensitivity was evaluated by measuring the number of remaining steps obtained as a cured film. As this value is larger, it is implied that the photosensitivity is higher.

### 5. Evaluation of Flexibility

The photosensitive resin composition for solder resist thus obtained was applied on a flexible substrate by a screen printing method, with a 120-mesh Tetron screen so as to obtain a thickness (after being dried) of about 30 μm. The coating film was dried in a hot air circulation type dryer for 30 minutes at 80° C., and thereby a photosensitive layer was formed. A negative mask having a predetermined pattern was closely adhered to the photosensitive layer, and the photosensitive layer was exposed to ultraviolet radiation at a dose of 500 mJ/cm² using an ultraviolet exposure apparatus. Subsequently, spray developing was performed using a 1% aqueous solution of sodium carbonate for 60 seconds at a pressure of 0.18 MPa, and the unexposed parts were dissolved. An image thus obtained was heated for one hour at 150° C., and thereby test plates (solder resists) of Examples and Comparative Examples were produced.

180-degree folding of a test plate by seam folding was repeatedly performed, and the number of times taken until cracks were generated in the test plate was observed with a microscope and evaluated according to the following criteria. That is, a case in which generation of cracks in the test plate was not recognized even if the test plate was folded 5 times or more was rated as “A”; a case in which the number of times taken until cracks were generated was 2 times or more and fewer than 5 times was rated as “B”; and a case in which the number of times taken until cracks were generated was fewer than 2 times was rated as “C”.

### 6. Evaluation of Tensile Strength

A short strip-shaped specimen (width: 8 mm, thickness: 1 mm) was cut out from a test plate. This specimen was used to measure the tensile strength with a STROGRAPH T (manufactured by Toyo Seiki Seisakusho Co., Ltd.) under the conditions of room temperature (25° C.), a distance between chucks of 30 mm, and a tensile rate of 10.0 mm/min.

TABLE 5

| | | | | | | Ref. | Ref. |
|---|---|---|---|---|---|---|---|
| | Ex. 3-1 | Ex. 3-2 | Ex. 3-3 | Ex. 3-4 | Ex. 3-5 | Ex. 3-1 | Ex. 3-2 |
| BACH (Synthesis | 1 | 0.5 | 2 | 1 | 1 | — | 1 |
| Example 3-1) | | | | | | | |
| PEG-PPG oligomer | 1 | 1 | 1 | 0.5 | 2 | 1 | — |
| (Synthesis Example | | | | | | | |
| 3-2) | | | | | | | |
| Acid-modified vinyl | 15 | 15 | 15 | 15 | 15 | 15 | 15 |
| group-containing | | | | | | | |
| bisphenol A type | | | | | | | |
| epoxy resin | | | | | | | |
| (Synthesis Example | | | | | | | |
| 3-3) | | | | | | | |
| Acrylonitrile | 15 | 15 | 15 | 15 | 15 | 15 | 15 |
| 2-Ethylhexyl | 15 | 15 | 15 | 15 | 15 | 15 | 15 |
| acrylate | | | | | | | |
| Barium sulfate | 5 | 5 | 5 | 5 | 5 | 5 | 5 |
| Silica | 5 | 5 | 5 | 5 | 5 | 5 | 5 |
| Talc | 4 | 4 | 4 | 4 | 4 | 4 | 4 |
| 1,3,5-Triglycdiyl | 18 | 18 | 18 | 18 | 18 | 18 | 18 |
| isocyanurate | | | | | | | |
| Irgacure 651 | 4 | 4 | 4 | 4 | 4 | 4 | 4 |
| KAYACURE | 1 | 1 | 1 | 1 | 1 | 1 | 1 |
| DETX-S | | | | | | | |
| Resolution (μm) | 60 | 60 | 60 | 60 | 60 | 120 | 120 |
| Photosensitivity | 15 | 15 | 14 | 14 | 15 | 14 | 13 |
| Flexibility | A | A | B | A | A | C | C |
| Tensile strength | 348 | 333 | 370 | 349 | 304 | 287 | 328 |
| (MPa) | | | | | | | |

It was confirmed that the solder resists of various Examples had high resolution and photosensitivity, and exhibit satisfactory flexibility and tensile strength.

### REFERENCE SIGNS LIST

1: Photosensitive element, 2: Support, 3: Photosensitive layer, 4: Protective layer, 10: Composite material, 11: Protective material, 13: Metal material, 13A: Metal material having a pattern, 15: Resin layer.

1. A composite material comprising a metal material; and a protective material provided on the surface of the metal material, the protective material being a cured product of a curable resin composition,
wherein the curable resin composition includes radical polymerizable monomers including a first monofunctional radical polymerizable monomer and a second monofunctional radical polymerizable monomer,
the first monofunctional radical polymerizable monomer is a monomer capable of forming, when polymerized alone, a homopolymer having a glass transition temperature of 20° C. or lower, and
the second monofunctional radical polymerizable monomer is a monomer capable of forming, when polymerized alone, a homopolymer having a glass transition temperature of 50° C. or higher.

2. The composite material according to claim 1, wherein the total content of the first monofunctional radical polymerizable monomer and the second monofunctional radical polymerizable monomer in the curable resin composition is 60% by mass or more based on the total amount of the radical polymerizable monomers.

3. The composite material according to claim 1, wherein the first monofunctional radical polymerizable monomer includes 2-ethylhexyl acrylate.

4. The composite material according to claim 1, wherein the second monofunctional radical polymerizable monomer includes at least one selected from the group consisting of acrylonitrile, dicyclopentanyl acrylate, and methyl methacrylate.

5. The composite material according to claim 1, wherein the radical polymerizable monomers further include a bifunctional radical polymerizable monomer and/or trifunctional radical polymerizable monomer.

6. The composite material according to claim 1, wherein the content of the first monofunctional radical polymerizable monomer is from 5% by mass to 90% by mass based on the total amount of the radical polymerizable monomers, and
the content of the second monofunctional radical polymerizable monomer is from 10% by mass to 95% by mass based on the total amount of the radical polymerizable monomers.

7. The composite material according to claim 1, wherein the curable resin composition further comprises a linear or branched polymer containing a polyoxyalkylene chain.

8. The composite material according to claim 7, wherein the polyoxyalkylene chain is a polyoxyethylene chain, a polyoxypropylene chain, or a combination thereof.

9. The composite material according to claim 7, wherein the polymer is a reaction product of a bifunctional alcohol having the polyoxyalkylene chain and a bifunctional isocyanate.

10. The composite material according to claim 9, wherein the number average molecular weight of the bifunctional alcohol is 500 to 20,000.

11. The composite material according to claim 7, wherein the proportion of the polyoxyalkylene chain in the polymer is 20% to 60% by mass based on the mass of the polymer.

12. The composite material according to claim 7, wherein the number average molecular weight of the polymer is 3,000 to 150,000.

13. The composite material according to claim 7, wherein the polymer contains two or more units of the polyoxyalkylene chain; and linking groups connecting those polyoxyalkylene chains, and each of the linking group has a cyclic group.

14. The composite material according to claim 7, wherein the content of the polymer in the curable resin composition is 1% to 20% by mass based on the mass of the curable resin composition.

15. A photosensitive resin composition for solder resist, the photosensitive resin composition comprising:
radical polymerizable monomers including a radical polymerizable compound represented by Formula (I): 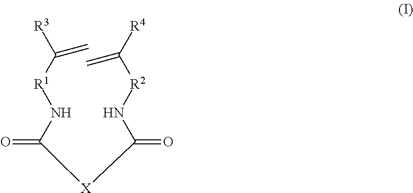
wherein X, R¹, and R² each independently represent a divalent organic group; and R³ and R⁴ each independently represent a hydrogen atom or a methyl group, and a monofunctional radical polymerizable monomer;
a linear or branched polymer; and
a photopolymerization initiator.

16. The photosensitive resin composition for solder resist according to claim 15, wherein the polymer is a polymer containing a polyoxyalkylene chain.

17. The photosensitive resin composition for solder resist according to claim 15, wherein the polymer is a polymer containing two or more linear chains; and linking groups connecting the terminals of the linear chains, and each of the linking groups is an organic group containing a cyclic group, or a branched organic group.

18. The photosensitive resin composition for solder resist according to claim 15, wherein the monofunctional radical polymerizable monomer include an alkyl (meth)acrylate having an alkyl group with 1 to 16 carbon atoms, the alkyl (meth)acrylate optionally having a substituent.

19. The photosensitive resin composition for solder resist according to claim 15, wherein the monofunctional radical polymerizable monomer includes acrylonitrile.

20. The photosensitive resin composition for solder resist according to claim 15, wherein
X in Formula (I) is a group represented by the following Formula (10):
*—Z¹—(CH₂)ᵢ—Y—(CH₂)ⱼ—Z²—* (10)
wherein Y represents a cyclic group optionally having a substituent; Z¹ and Z² each independently represent a functional group containing an atom selected from a carbon atom, an oxygen atom, a nitrogen atom, and a sulfur atom; i and j each independently represent an integer from 0 to 2; and the symbol * represents a linking point.

21. The photosensitive resin composition for solder resist according to claim 15, wherein the weight average molecular weight of the polymer is 5,000 or more.

22. A photosensitive element, comprising:
a support; and
a photosensitive layer provided on the support and containing the photosensitive resin composition for solder resist according to claim 15.
